(19) United States
(12) Patent Application Publication
(10) Pub. No.: US 2017/0092954 A1
(43) Pub. Date: Mar. 30, 2017

(54) MULTI-LAYER CARBON-SULFUR CATHODES

(71) Applicant: Board of Regents, The University of Texas System, Austin, TX (US)

(72) Inventors: Arumugam Manthiram, Austin, TX (US); Sheng-Heng Chung, Austin, TX (US)

(21) Appl. No.: 15/265,586

(22) Filed: Sep. 14, 2016

Related U.S. Application Data
(60) Provisional application No. 62/232,981, filed on Sep. 25, 2015.

(51) Int. Cl. H01M 4/62; H01M 4/38; H01M 4/36

(52) U.S. Cl. CPC H01M 4/628; H01M 4/366; H01M 4/38; H01M 2004/028

(57) ABSTRACT

The present disclosure relates to a cathode for a Li—S battery including a first carbon layer, a second carbon layer, and a S-based cathode active material composition between the first and second carbon layers. At least one of the first and second carbon layers allows passage of lithium ions, while substantially preventing passage of polysulfides. Such a carbon layer may include a nanocarbon paper. The nanocarbon paper may include curved carbon nanotubes attached to a carbon nanofiber skeleton to form a binder-free SP²-hydridized carbon framework.

### PRIORITY CLAIM

The present application claims priority under 35 U.S.C. §119(e) to United States Provisional Patent Application Ser. No. 62/232,981, filed Sep. 25, 2015, titled “MULTI-LAYER CARBON-SULFUR CATHODES,” which is incorporated by reference herein in its entirety.

### STATEMENT OF GOVERNMENT INTEREST

This invention was made with United States Government support under Grant no. DE-SC0005397 awarded by the Department of Energy. The United States Government has certain rights in the invention.

### TECHNICAL FIELD

The present disclosure relates to a cathode containing carbon and sulfur for use in a rechargeable lithium-sulfur (Li—S) battery.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode (cathode) and the negative electrode (anode), an insulator separating the electrodes so the battery does not short out, and an electrolyte that chemically connects the electrodes.

In operation, the secondary battery exchanges chemical energy and electrical energy. During discharge of the battery, electrons (e), which have a negative charge (−), leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge (+) leaves the anode and enters the electrolyte and then a positive ion leaves the electrolyte and enters the cathode. In order for this ion movement to work, typically the same type of ion leaves the anode and joins the cathode. Additionally, the electrolyte typically also contains this same type of ion.

In order to recharge the battery, the same process happens in reverse. By supplying energy to the cell, electrons are induced to leave the cathode and join the anode. At the same time, a positive ion, such as a lithium ion (Li⁺), leaves the cathode and enters the electrolyte and a Li⁺ leaves the electrolyte and joins the anode to keep the overall electrode charge neutral.

In addition to containing an active material that exchanges electrons and ions, anodes and cathodes often contain other materials, such as a metal backing to which a slurry is applied and dried. The slurry often contains the active material as well as a binder to help it adhere to the backing and conductive materials, such as a carbon particles. Once the slurry dries, it forms a coating on the metal backing. The metal backing is electrically conductive and electrically connects the active material to other parts of the battery and, ultimately, the exterior of the battery. Because the metal backing accumulates electrical current from the active material, it is also often referred to as a “current collector.”

Several important properties of rechargeable batteries include energy density, power density, rate capability, cycle life, cost, and safety. Current lithium ion battery technology based on insertion compound cathodes and anodes is limited in energy density. This technology also suffers from safety concerns arising from the chemical instability of oxide cathodes under conditions of overcharge and also frequently requires the use of expensive transition metals. Accordingly, there is immense interest in developing alternative cathode materials for lithium ion batteries. Sulfur has been considered as one such alternative cathode material.

### Lithium-Sulfur Batteries

Lithium-sulfur (Li—S) batteries are a particular type of rechargeable battery that contain sulfur (S) as the cathode active material. S is an attractive cathode active material candidate as compared to traditional lithium ion battery cathode active materials because it offers an order of magnitude higher theoretical capacity (1672 mAh g⁻¹) than the currently employed cathode active materials (<200 mAh g⁻¹) and operates at a safer voltage range (1.5-3.0 V). This high theoretical capacity is due to the ability of S to accept two electrons (e⁻) per atom. In addition, sulfur is inexpensive and environmentally benign.

In addition, unlike current lithium ion batteries in which the Li⁺ actually moves into and out of the crystal lattice of an insertion compound, the Li⁺ in Li—S batteries reacts with sulfur in the cathode to produce a discharge product with different crystal structure. The Li⁺ does not need to move into and out of either the sulfur or the discharge product. Rather, during discharge, particles of elemental sulfur (S) react with the Li⁺ to form Li₂S in the cathode. When the battery is recharged, lithium ions (Li⁺) leave the cathode, allowing to revert to elemental sulfur (S).

In most Li—S batteries, the anode is lithium metal (Li or Li⁰). In operation, lithium leaves the metal as Li⁺ and enters the electrolyte when the battery is discharging. When the battery is recharged, Li⁺ leave the cathode and plate out on the lithium metal anode as Li. Although lithium metal anodes are often preferred because they confer the highest possible operating voltage and also do not require Li⁺ to move into and out of a crystal lattice, other Li⁺ anodes, including those based on insertion compounds, may also be used in a Li—S battery. Typically, these anodes operate by releasing Li⁺ into the electrolyte when the battery is discharging and by removing Li⁺ from the electrolyte when the battery is recharged.

Despite the potential advantages of Li—S batteries, their practical applicability is currently limited by their poor cycle stability, poor capacity retention, and low Coulombic efficiency, irreversible capacity loss.

These disadvantages arise because, during discharge, the S cathode active material does not react with Li⁺ to immediately form Li₂S. Rather, polysulfides are formed as an intermediate reaction product. These polysulfides dissolve easily in the electrolyte and, as a result, are often not located at the cathode when the battery recharged, resulting in irreversible loss of S cathode active material. As these losses accumulate over time, eventually the battery becomes unusable.

In one particularly problematic effect of electrolyte solubility, high-order polysulfides (Li₂Sₙ, 4≦n≦8) move toward the lithium metal anode, where they are reduced to lower-order polysulfides. These lower order polysulfides ((Li₂Sₙ, 1≦n≦2) are markedly less soluble than high-order polysulfides or are insoluble in the electrolyte. As a result, they remain near the anode and may even nucleate to form larger, insoluble particles.

In addition to problems caused by polysulfides not being located at the cathode, high-order polysulfides may shuttle through the electrolyte between the cathode and the anode to participate in parasitic reactions with Li⁺ at the anode and re-oxidation at the cathode. This process results in lithium dendrite formation, which may cause a short circuit within the battery, depletion of Li⁺ from the electrolyte, which impairs its ability to function, and the eventual build-up of a thick, irreversible Li₂S/Li₂S₂ barrier on the anodes, which is insoluble and nonconductive and blocks Li⁺.

In addition, S has a volume of 2.07 g/cm³, while Li₂S has a volume of 1.66 g/cm³. This 80% volume change in the cathode active material between charged and discharged states of the Li—S battery causes structural disintegration in many cathode designs, resulting in increasing lack of adequate electrical contact between the S and the current collector and eventual failure of the battery.

Recent improvements in cathode design, such as the implementation of conductive porous materials to encapsulate sulfur within the cathode and suppress polysulfide shuttling, have produced Li—S batteries having high performance. Such improvements, however, are associated with limited S content (and thus limited cathode capacity and limited energy density) and limited cycle time. With increased sulfur content or extended cycle time, polysulfide dissolution and shuttling are inevitable in such cathodes and directly impair the stability of the lithium metal anode, as parasitic reactions between dissolved polysulfides and the lithium metal anode lead to lithium dendrite formation and electrolyte depletion as noted above.

Accordingly, a need exists for Li—S battery that reduces polysulfide movement away from the cathode, while allowing higher S content, higher cathode capacity, or higher energy density.

### SUMMARY

The present disclosure relates to a cathode for a Li—S battery including a first carbon layer, a second carbon layer, and a S-based cathode active material composition between the first and second carbon layers. At least one of the first and second carbon layers allows passage of lithium ions, while substantially preventing passage of polysulfides. Such a carbon layer may include a nanocarbon paper. The nanocarbon paper may include curved carbon nanotubes attached to a carbon nanofiber skeleton to form a binder-free SP²-hydridized carbon framework.

### BRIEF DESCRIPTION OF THE DRAWINGS

A more complete understanding of the present embodiments and advantages thereof may be acquired by referring to the following description taken in conjunction with the accompanying drawings, which relate to embodiments of the present disclosure. The current specification contains color drawings. Copies of these drawings may be obtained from the USPTO.

FIG. 1 is a cross-sectional schematic view of a cathode containing two carbon layers and a S-based cathode active material.

FIG. 2 is a cross-sectional schematic view of a cathode containing four carbon layers and a S-based cathode active material.

FIG. 3 is a partial cross-sectional view of a jelly-roll Li—S battery containing a S-based cathode active material.

FIG. 4A is a low-resolution scanning electron microscope (SEM) image of a carbon layer suitable for use in a cathode of the present disclosure.

FIG. 4B is a high-resolution SEM image of a carbon layer suitable for use in a cathode of the present disclosure.

FIG. 4C is a combined high/low-resolution SEM image of a carbon layer suitable for use in a cathode of the present disclosure.

FIG. 5A is a nitrogen adsorption-desorption isotherms plot of a carbon layer suitable for use in a cathode of the present disclosure.

FIG. 5B is a pore-size distribution plot of a carbon layer suitable for use in a cathode of the present disclosure.

FIG. 6A is a combined high/low-resolution SEM image and elemental analysis of the external surface of a carbon layer assembled into an uncycled cathode of the present disclosure.

FIG. 6B is a low-resolution SEM image and elemental analysis of the external surface of a carbon layer assembled into an uncycled cathode of the present disclosure.

FIG. 6C is a high-resolution SEM image and elemental analysis of the external surface of a carbon layer assembled into an uncycled cathode of the present disclosure.

FIG. 7A is a photograph of an uncycled cathode of the present disclosure.

FIG. 7B is a set of photographs of a rolled, then recovered uncycled cathode of the present disclosure.

FIG. 7C is a set of photographs of a multifolded, then recovered uncycled cathode of the present disclosure.

FIG. 8A is a photograph of a cathode of the present disclosure after 400 cycles in a Li—S coin cell.

FIG. 8B is a set of photographs of a rolled, then recovered cathode of the present disclosure after 400 cycles in a Li—S coin cell.

FIG. 8C is a set of photographs of a multifolded, then recovered cathode of the present disclosure after 400 cycles in a Li—S coin cell.

FIG. 9A is a low-resolution SEM image and elemental analysis of the external surface of a carbon layer on the current collector side of a cathode of the present disclosure after 400 cycles in a Li—S coin cell.

FIG. 9B is a low-resolution SEM image and elemental analysis of the external surface of a carbon layer on the current collector side of a cathode of the present disclosure after 400 cycles in a Li—S coin cell.

FIG. 9C is a low-resolution SEM image and elemental analysis of the external surface of a carbon layer on the current collector side of a cathode of the present disclosure after 400 cycles in a Li—S coin cell.

FIG. 9D is a high-resolution SEM image and elemental analysis of the external surface of a carbon layer on the current collector side of a cathode of the present disclosure after 400 cycles in a Li—S coin cell.

FIG. 10A is a low-resolution SEM image and elemental analysis of the external surface of a carbon layer on the anode-facing side of a cathode of the present disclosure after 400 cycles in a Li—S coin cell.

FIG. 10B is a low-resolution SEM image and elemental analysis of the external surface of a carbon layer on the anode-facing side of a cathode of the present disclosure after 400 cycles in a Li—S coin cell.

FIG. 10C is a low-resolution SEM image and elemental analysis of the external surface of a carbon layer on the anode-facing side of a cathode of the present disclosure after 400 cycles in a Li—S coin cell battery.

FIG. 10D is a high-resolution SEM image and elemental analysis of the external surface of a carbon layer on the anode-facing side of a cathode of the present disclosure after 400 cycles in a Li—S coin cell.

FIG. 11A is a low-resolution SEM image and elemental analysis of a cross-section of an uncycled cathode of the present disclosure.

FIG. 11B is a line scanning graph of the elemental analysis of FIG. 11A.

FIG. 12A is a low-resolution SEM image and elemental analysis of a cross-section of a cathode of the present disclosure after 400 cycles in a Li—S coin cell battery.

FIG. 12B is a line scanning graph of the elemental analysis of FIG. 12A.

FIG. 13A is a low-resolution SEM image of the S-based cathode material of an uncycled cathode of the present disclosure.

FIG. 13B is a low-resolution SEM image of the S-based cathode material of a cathode of the present disclosure after 400 cycles in a Li—S coin cell.

FIG. 13C is a low-resolution SEM image of the S-based cathode material of a conventional reference cathode after 50 cycles in a Li—S coin cell.

FIG. 13D is a low-resolution SEM image and elemental analysis of a cathode of the present disclosure after 400 cycles in a Li—S coin cell, scratched to reveal the S-based cathode active material; the inset is a separator form the same battery.

FIG. 13E is a low-resolution SEM image and elemental analysis of the anode of the battery of FIG. 13D.

FIG. 14 is electrochemical impedance spectroscopy (EIS) analysis of a cathode of the present disclosure and a reference S-based cathode before and after cycling.

FIG. 15A is a discharge/charge voltage profile for a cathode of the present disclosure at a 0.2 C rate.

FIG. 15B is a discharge/charge voltage profile for a cathode of the present disclosure at a 0.5 C rate.

FIG. 15C is a discharge/charge voltage profile for a cathode of the present disclosure compared to a conventional S-based cathode at a 0.2 C rate.

FIG. 15D is a discharge/charge voltage profile for a cathode of the present disclosure compared to a conventional S-based cathode at a 0.5 C rate.

FIG. 16 is cycling profiles of the Li—S coin cell battery cells employing cathodes of the present disclosure and a reference conventional S-based cathode.

FIG. 17A is the Q_{H} (upper part) and its retention rate (R_{QH}: lower part) for a cathode according to the present disclosure and a reference conventional S-based cathode.

FIG. 17B is the Q_{L} (upper part) and its retention rate (R_{QL}: lower part) for a cathode according to the present disclosure and a reference conventional S-based cathode.

FIG. 17C is the Q_{L}/Q_{H} for a cathode according to the present disclosure and a reference conventional S-based cathode with different S-loadings.

FIG. 18A is a discharge capacity graph for cathodes of the present disclosure with different S-loadings.

FIG. 18B is an areal capacity graph for cathodes of the present disclosure with different S-loadings.

FIG. 18C is a volumetric capacity graph for cathodes of the present disclosure with different S-loadings.

FIG. 18D is a discharge/charge voltage profile for cathodes of the present disclosure with different S-loadings.

FIG. 18E is a cyclability graph at a 0.2 C rate for cathodes of the present disclosure with different S-loadings.

FIG. 19A is a discharge capacity graph for cathodes of the present disclosure with different S-loadings coupled with a carbon-coated separator.

FIG. 19B is an areal capacity graph for cathodes of the present disclosure with different S-loadings coupled with a carbon-coated separator.

FIG. 19C is a volumetric capacity graph for cathodes of the present disclosure with different S-loading coupled with a carbon-coated separator.

FIG. 19D is a discharge/charge voltage profile for cathodes of the present disclosure with different S-loadings coupled with a carbon-coated separator.

FIG. 19E is a cyclability graph at a 0.2 C rate for cathodes of the present disclosure with different S-loadings coupled with a carbon-coated separator.

FIG. 20A is a cyclability graph at a 0.2 C rate for a cathode of the present disclosure after rolling and folding, a cathode of the present disclosure used with a LiNO₃-free electrolyte, and an unrolled/folded cathode of the present disclosure.

FIG. 20B is a cyclability graph at a 0.2 C rate for the cathode of FIG. 8 after rolling and folding, a cathode of the present disclosure used with a LiNO₃-free electrolyte, and an unrolled/folded cathode of the present disclosure.

FIG. 20C is EIS analysis of a cathode of the present disclosure after rolling and folding, a cathode of the present disclosure used with a LiNO₃-free electrolyte, and an unrolled/folded cathode of the present disclosure.

### DETAILED DESCRIPTION

The present disclosure relates to a cathode containing at least two layers of carbon able to trap polysulfides with a S-based active material between the carbon layers. The cathode may be used in a rechargeable Li—S battery.

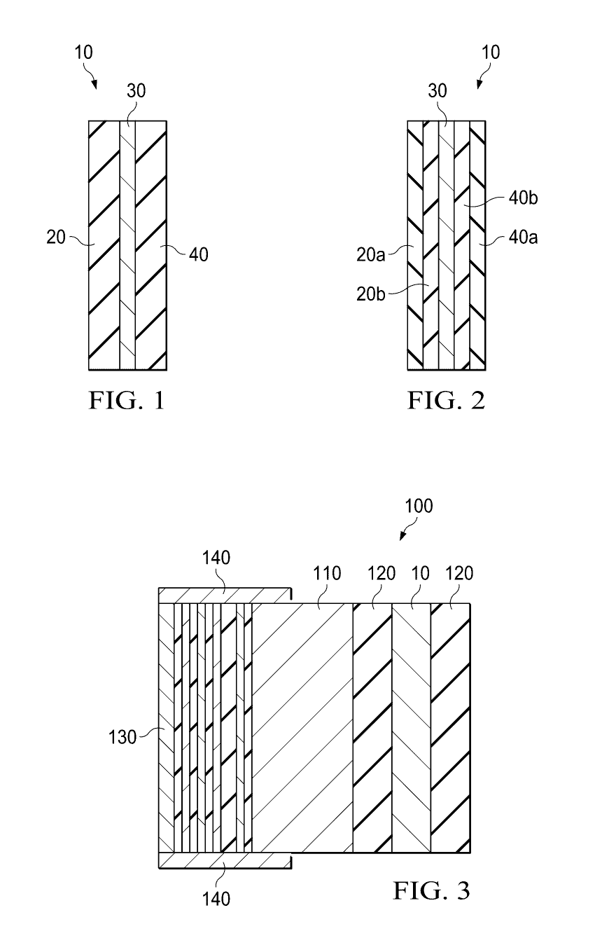

FIG. 1 is a cross-sectional schematic view of cathode 10, formed from a first carbon layer 20, a S-based cathode active material composition 30, and a second carbon layer 40. At least one of first carbon layer 20 and second carbon layer 40 allows passage of Li⁺, while substantially preventing polysulfides in S-based cathode active material 30 from exiting cathode 10 during operation of a Li—S battery containing cathode 10.

Cathode 10 may be designed such that first carbon layer 20 and second carbon layer 40 are formed from the same material, as shown in FIG. 1 or they may be formed from different materials. Use of the same material for both layers provides a cathode 10 that is not sensitive to orientation within a battery and thus easier to make and use and less prone to causing battery manufacturing errors. In addition, in some battery configurations where cathode 10 is layered between two anodes (and separators), then both first and second carbon layer will serve the same function in the cathode, such that use of the same material for both is desirable.

However, in battery configurations where first carbon layer 20 primarily serves to retain polysulfides, while second carbon layer 40 primarily serves as a current collector, it may be desirable to use different materials for the different carbon layers. For instance, first carbon layer 20 may have more specific property requirements than second carbon layer 40, making first carbon layer 20 more difficult and expensive to fabricate. An easier-to-fabricate, cheaper material may be used for second carbon layer 40.

Furthermore, although FIG. 1 depicts a cathode 10 with only two carbon layers, 20 and 40, multiple carbon layers may be present on either or both sides of S-based cathode material composition 30. For instance, two first carbon layers 20 may be used to better retain polysulfides, particularly when it is difficult to simply fabricate a thicker single first carbon layer 20. When multiple first carbon layers 20 are present, they may be formed from the same material or different materials. Similarly, when multiple second carbon layers 40 are present, they may be formed from the same material or different materials.

FIG. 2 illustrates a cathode 10 for use in a battery in which it is layered between two anodes (and separators). Cathode 10 contains two first layers, 20a and 20b, and two second layers, 40a and 40b. Layers 20b and 40b, which contact S-based cathode active material 30, are more electrically conductive than layers 20a and 40a. Outer layers 20a and 40a, however, are better at retaining polysulfides than layers 20b and 40b.

Any carbon layer 20 or 40 that will face an anode (and separator) may be formed from a porous carbon material able to retain polysulfides substantially preventing polysulfides in S-based cathode active material composition 30 from exiting cathode 10 during operation of a Li—S battery containing cathode 10, while allowing passage of Li⁺. This effect is achieved by high tortuosity of paths through the carbon layer. In addition to retaining polysulfides, the carbon layer is also conductive, allowing electrons to reach trapped cathode active material so that it may be reused in subsequent battery cycles.

Such a carbon layer may be formed from a nanocarbon paper, also referred to as “buckypaper.” Nanocarbon paper may include single-walled carbon nanotubes, double-walled carbon nanotubes, multi-walled carbon nanotubes, carbon nanofibers, nanoscale graphene platelets, and any combinations thereof. Nanocarbon paper may also include spherical carbon powders, carbon black powders, microporous carbon powders, mesoporous carbon powders, and any combinations thereof with polymeric binders. Nanocarbon paper may vary in areal weight from 20 g/m² to 60 g/m². In particular, nanocarbon paper may include curved carbon nanotubes attached to a carbon nanofiber skeleton to form a binder-free SP²-hydridized carbon framework.

The carbon nanotubes may be between 10 nm and 30 nm in average width, between 15 nm and 25 nm in average width, or between 18 nm and 22 nm in average width. The carbon nanofibers may be between 30 μm and 70 μm in average length, between 40 μm and 60 μm in average length, or between 45 μm and 55 μm in average length. The carbon nanofibers may also be between 140 nm and 180 nm in average width, between 150 nm and 170 nm in average width, and between 155 nm and 165 nm in average width.

The carbon layer may have an average pore size of 350 nm or less in any one dimension, an average pore size of 200 nm or less in any one dimension, or an average pore size of 50 nm or less in any one dimension. Small pores may be significant in retaining polysulfides, particularly high-order polysulfide.

The carbon layer may have a total pore volume of at least 0.2 cm³/g, at least 0.4 cm³/g, at least 0.7 cm³/g, or at least 1 cm³/g. This high porosity creates a highly tortuous path through the carbon layer, which helps retain polysulfides because of the difficulties in migrating through a carbon layer with high tortuosity.

Typically both or all carbon layers 20 and 40 will be formed from a porous carbon material as described above because any carbon layer that is a current collector also benefits from the presence of the S-based cathode active material, such as S or polysulfides, in its pores, as this increases cathode conductivity and active material utilization.

However, so long as one carbon layer 20 or 40 retains polysulfides to restrict their migration away from cathode 10 as described above, the other carbon layers 20 or 40 may be formed from any conductive carbon paper or other woven or non-woven carbon sheet or film.

S-based cathode active material composition 30 may include elemental sulfur, including, without limitation, crystalline sulfur, amorphous sulfur, precipitated sulfur, and melt-solidified sulfur. S-based cathode active material composition 30 may include a sulfur compound, including sulfides, polysulfides, sulfur oxides, organic materials comprising sulfur, and combinations thereof.

When S-based cathode active material composition 30 includes a solid material, that solid material may be in the form of small particles or aggregates, such as particles or aggregates no larger than 1000 μm in average largest dimension, particles or aggregates no larger than 500 μm in average largest dimension, particles or aggregates no larger than 100 μm in average largest dimension, particles or aggregates no larger than 10 μm in average largest dimension, particles or aggregates no larger than 1 μm in average largest dimension, particles or aggregates no larger than 500 nm in average largest dimension, particles or aggregates no larger than 100 nm in average largest dimension, or particles or aggregates no larger than 10 nm in average largest dimension.

S-based active material composition 30 may include other materials in addition to the S-based active material, such as binders and conductivity enhancers.

S-based cathode active material composition 30 may be a catholyte, such as a polysulfide catholyte. A “catholyte” as used herein, refers to a battery component that functions both as an electrolyte and contributes to the cathode. By way of example and not limitation, suitable catholytes and cathodes are disclosed in U.S. Patent No. 2013/0141050 to Visco et al. and U.S. patent application Ser. No. 13/793,418 to Manthiram et al., filed Mar. 11, 2013, both of which are hereby incorporated by reference in their entireties.

The polysulfide catholyte may contain a polysulfide. The polysulfide may have a nominal formula of Li₂S₆. The polysulfide may have the formula Li₂Sₙ, where 4≦n≦8. The polysulfide may be present in an amount with a sulfur concentration of 1-8 M, more specifically, 1-5 M, even more specifically 1-2 M. For example, it may be present in a 1M amount, a 1.5 M amount, or a 2 M amount. The catholyte may also contain a material in which the polysulfide is dissolved. For example, the catholyte may also contain LiCF₃SO₃, LiTFSI, LiNO₃, dimethoxy ethane (DME), 1,3-dioxolane (DOL), tetraglyme, other lithium salt, other ether-based solvents, and any combinations thereof.

Cathode 10 may be manufactured by coating the S-based cathode active material composition 30 on one or both of carbon layers 20 and 40, then assembling carbon layers 20 and 40 with S-based cathode active material between them. For instance, when S-based cathode active material 30 is a solid, a slurry containing it may be formed and coated on one or both carbon layers 20 and 40. In one method, the slurry may be tape-cast on one or both carbon layers 20 and 40, then one layer 20 or 40 may be used to cover the other layer. When S-based cathode active material composition 30 is a catholyte, it may be coated on one or both carbon layers 20 and 40 using a catholyte absorption method.

If different materials are used for carbon layers 20 and 40, then the best suited material may be coated. If multiple carbon layers 20 or multiple carbon layers 40 are used, they may be assembled prior to or after coating with S-based cathode active material composition 30.

Cathode 10 may be flexible and have high mechanical strength, allowing its use in a variety of battery configurations, including those with irregular shapes.

Unless additional materials are specified, Li—S batteries as described herein include systems that are merely electrochemical cells, such as those described in the background, but with cathode 10. Li—S batteries as described herein include simple battery formats, such as coin cells and jelly rolls. The high flexibility of cathode 10 may make it particularly well-suited for use in jelly rolls.

Li—S batteries as described herein may also include more complex battery formats, such as prismatic cells or irregular-shaped batteries. The high flexibility of cathode 10 may make it particularly well-suited for irregular-shaped batteries as well. Li—S batteries of the present disclosure may contain contacts, a casing, or wiring. In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components. Batteries that contain more than one electrochemical cell and may contain components to connect or regulate these multiple electrochemical cells.

Li—S batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

FIG. 3 is a partial cross-sectional view of a jelly-roll Li—S battery 100 containing cathode 10 and anode 110 separated by separator 120 and rolled to fit into can 130, which is closed by caps 140.

Anode 110 may be any anode suitable for use in a Li—S battery, including, but not limited to, lithium metal, or a current collector coated with an anode active material.

Separator 120 may be an electrically insulative separator, such as a polymer, gel, or ceramic.

A further separator to trap polysulfides may be included between cathode 10 and separator 120. This separator may be conductive. For instance, it may be a polyethylene glycol (PEG)-supported MPC-coated separator (MPC/PEG-coated separator).

Li—S battery 100 further contains an electrolyte (not shown) that is contained by can 130 and caps 140. If the electrolyte includes a solid electrolyte, separator 120 may include the solid electrolyte. If the electrolyte includes a liquid or gel electrolyte, it may permeate separator 120, cathode 10, anode 110, or any combination thereof. The electrolyte may include combinations of liquid, gel, and solid electrolytes.

The electrolyte may be non-aqueous to avoid deleterious effects of water. For instance, if may include a nonionic liquid or an ionic liquid, such an organic solvent or mixture of organic solvents. The electrolyte may further include an ionic lithium electrolyte salt, such as, LiSCN, LiBr, LiI, LiClO4, LiAsF₆, LiCF₃SO₃, LiSO₃CH₃, LiBF₄, LiB(Ph)₄, LiPF₆, LiC(SO₂CF₃)₃, LiN(SO₂CF₃)₂, and combinations thereof

Batteries of the present disclosure may have at least one or any combinations of the following properties:
a capacity fade of no more than 0.6%, 0.8%, or 1.0% per cycle for at least 400 cycles;
a cathode areal capacity of at least 5 mAh/cm², at least 6 mAh/cm², or at least 7 mAh/cm², as measured per surface area of one carbon layer;
a cathode S loading of at least 3 mg/cm², at least 4 mg/cm², or at least 5 mg/cm², as measured per surface area of one carbon layer;
a cathode volumetric capacity of at least 250 mAh/cm³, at least 275 mAh/cm³, or at least 300 mAh/cm³;
a cathode weight capacity of at least 450 mAh/g, at least 475 mAh/g, or at least 500 mAh/g;
a initial discharge capacity of at least 750 mAh/g, at least 775 mAh/g, or at least 800 mAh/g;
lack of cathode delamination when rolled or folded;
lack of cathode disintegration due to volume changes in cathode active material between charge and discharge;
lack of electrical conductivity loss due to volume changes in cathode active material between charge and discharge; and
lack of rapid fade of Q_{H} (R_{Q}H) and Q_{L} (R_{QL}) during cell charge and discharge.

The details of these processes and battery components that may be formed are described above or in the following examples.

### EXAMPLES

The following examples are provided to further illustrate specific embodiments of the disclosure. They are not intended to disclose or describe each and every aspect of the disclosure in complete detail and should not be so interpreted.

### Example 1—Buckypaper/Sulfur/Buckypaper (B/S/B) Cathode Fabrication

A S-based cathode active material composition was prepared by mixing commercial sulfur (Fisher Scientific, Massachusetts, US) with carbon black (SUPER P®, Imerys Graphite & Carbon, Switzerland) and polyvinylidene fluoride (PVDF: Grade No. L#1120, Kureha, Japan) in a mass ratio of 4.7:1:1. The mixture was stirred for 48 hours with N-methyl-2-pyrrolidone (NMP; Sigma-Aldrich, Missouri, US) for 48 h. The resulting viscous mixture was coated onto a 20 GSM commercial buckypaper (NanoTechLabs, Inc., North Carolina, US) by tape-casting via an automatic film applicator (1132N, Sheen, UK) at a traverse speed of 25 mm/s. Then, another layer of buckypaper was placed on the sulfur-coated buckypaper to form a buckypaper/sulfur/buckypaper (B/S/B) cathode. Finally, the NMP solvent was evaporated for 48 h at 50° C. in an air oven.

The flexible B/S/B cathodes were cut into circular discs 12 mm in diameter with a thickness of approximately 100 μm and a sulfur loading of approximately 3.2 mg/cm² (B/S/B-3 cathodes: total sulfur mass is 3.2 mg/cm²×1.13 cm⁻²=3.6 mg).

A series of B/S/B-x cathodes were prepared by tape-casting to investigate a range of sulfur-loadings from 1.0 mg/cm² sulfur (B/S/B-1 cathodes) to 5.1 mg/cm² sulfur (B/S/B-5 cathodes). Sulfur loading was controlled by using 8-path applicators (PG&T Co., Ohio, US) and increased by adjusting the path depth from 5 mils to 30 mils.

Conventional sulfur cathodes for use a reference cathode were similarly prepared by tape-casting using an aluminum (Al) foil as the current collector. The conventional sulfur cathodes had a cathode active-material loading of approximately 2.0 mg/cm² (S-2 cathodes: total sulfur mass is 2.0 mg/cm²×1.13 cm⁻²=˜2.3 mg).

### Example 2—Li—S Cells Employing the B/S/B Cathode

B/S/B cathodes (for test cells), conventional sulfur cathodes (for reference cells), polypropylene separators (Celgard 2500, Celgard, North Carolina, US), and nickel foam spacers (Pred Materials, Inc., New York, US) were dried in a vacuum oven at 50° C. for 1 h, then assembled in an argon-filled glove box into a CR2032 coin cell with a lithium metal foil anode and a blank electrolyte. The blank electrolyte contained 1.85 M LiCF₃SO₃ salt (Acros Organics, Thermo Fisher, New Jersey, US) and 0.1 M LiNO₃ co-salt (Acros Organics) in a 1:1 volume ratio of 1,2-Dimethoxyethane (DME; Acros Organics) and 1,3-Dioxolane (DOL; Acros Organics). The assembled Li—S cells were allowed to rest for 30 min before electrochemical cycling.

### Example 3—Characterization of the B/S/B Cathodes

Cycled B/S/B cathodes (400 cycles, at charged state) and cycled conventional sulfur cathodes (50 cycles, at charged state) were retrieved from their respective coin cells inside an argon-filled glove box 30 min prior to analysis. The cycled samples were rinsed with 1:1 volume ratio of DME/DOL solution, wiped by Kimwipes® (Kimberly-Clark, Wisconsin, US), and sealed into an argon-filled sealed vessel during sample transfer.

The B/S/B cathodes or reference cathodes and their morphological changes before and after cycling were observed with a field emission scanning electron microscope (FE-SEM) (Quanta 650 SEM, FEI, Oregon, US) with energy dispersive X-ray spectrometers (EDX) for collecting elemental signals, and line scanning and elemental mapping results.

Nitrogen adsorption-desorption isotherms were measured at 77 K with an automated gas sorption analyzer (AutoSorb iQ2, Quantachrome Instruments, Florida, US).

Surface area was calculated by the Brunauer-Emmett-Teller (BET) method.

Pore-size distributions and pore volumes were determined by the Barrett-Joyner-Halenda (BJH) method.

Porosity was analyzed by a t-plot with carbon black model.

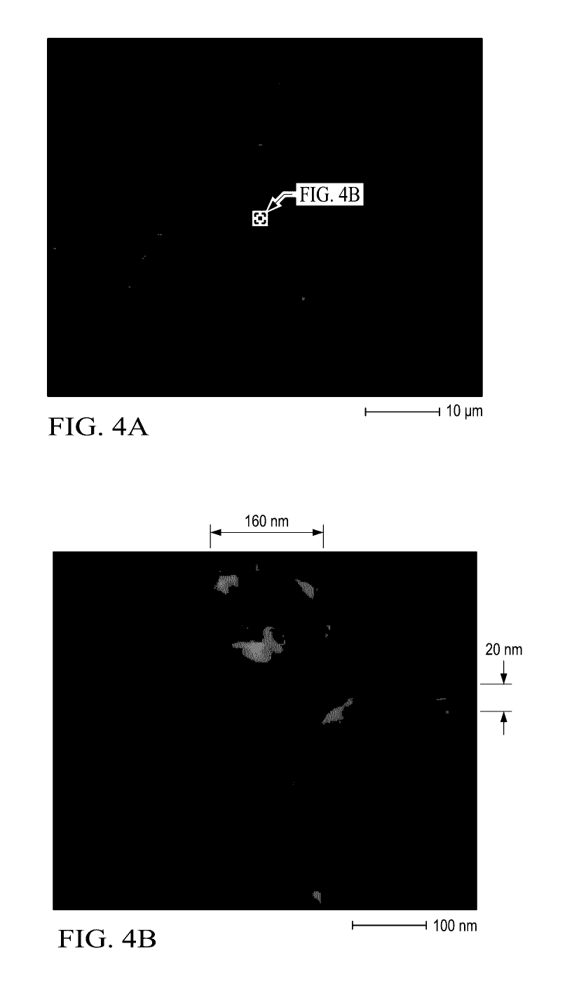

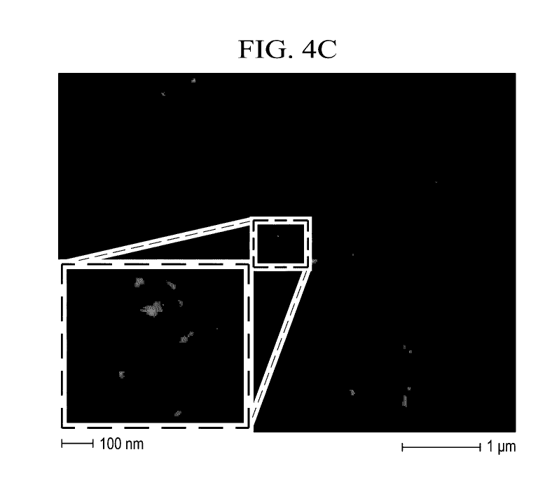

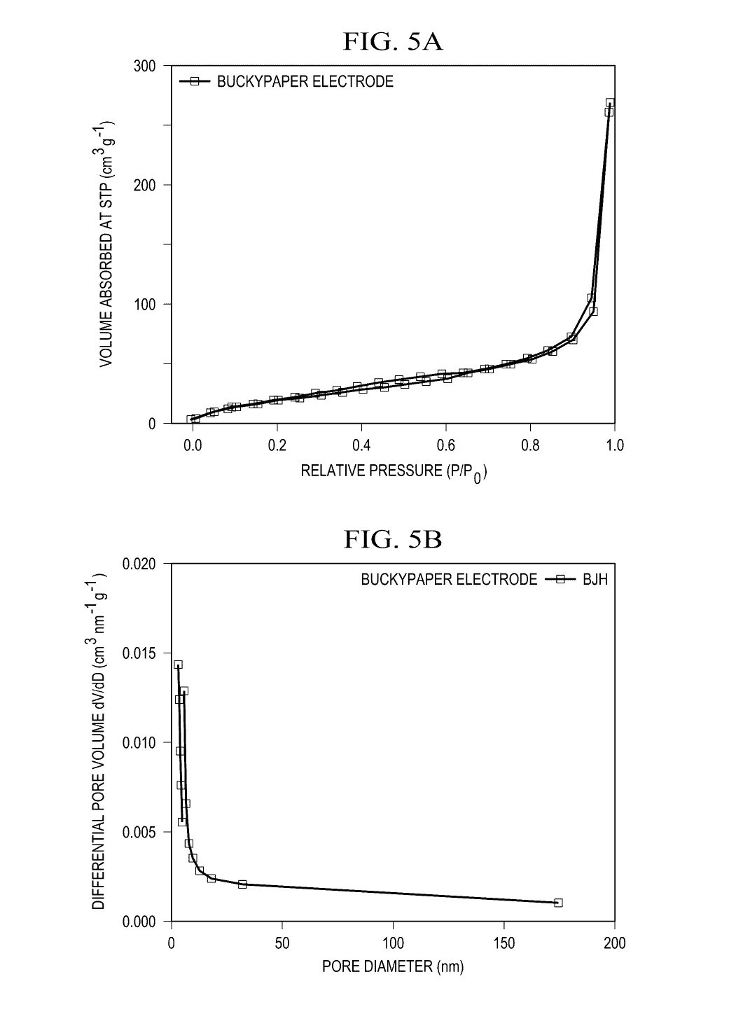

The surface SEM images in FIG. 4A, FIG. 4B, and FIG. 4C indicate that the buckypaper had a long-range fibrous architecture composed of curved carbon nanotubes (CNT; width: approximately 20 nm) firmly attached to a carbon nanofiber skeleton (CNF; length: >50 μm; width: approximately 160 nm). This binder-free SP²-hybridized carbon framework had surface electrical resistivity of 1.51 Ohm/square. The woven CNT-CNF framework was also highly porous, which created strong tortuosity for free polysulfide migration. The porosity analysis of the buckypaper summarized in FIG. 5A and FIG. 5B indicate that the buckypaper had high macroporosity according to the IUPAC Type II isotherms and had a surface area of 82 m²/g and a total pore volume of 0.42 cm³/g. Only pore sizes smaller than 309 nm were detectable using the instrument settings. Average pore size was 20.38 nm and the external surface area was 81 m²/g.

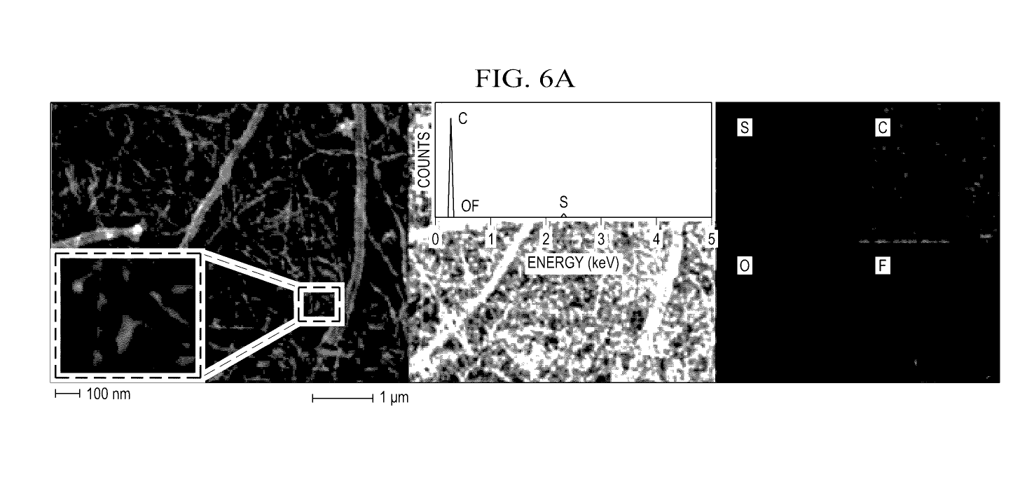

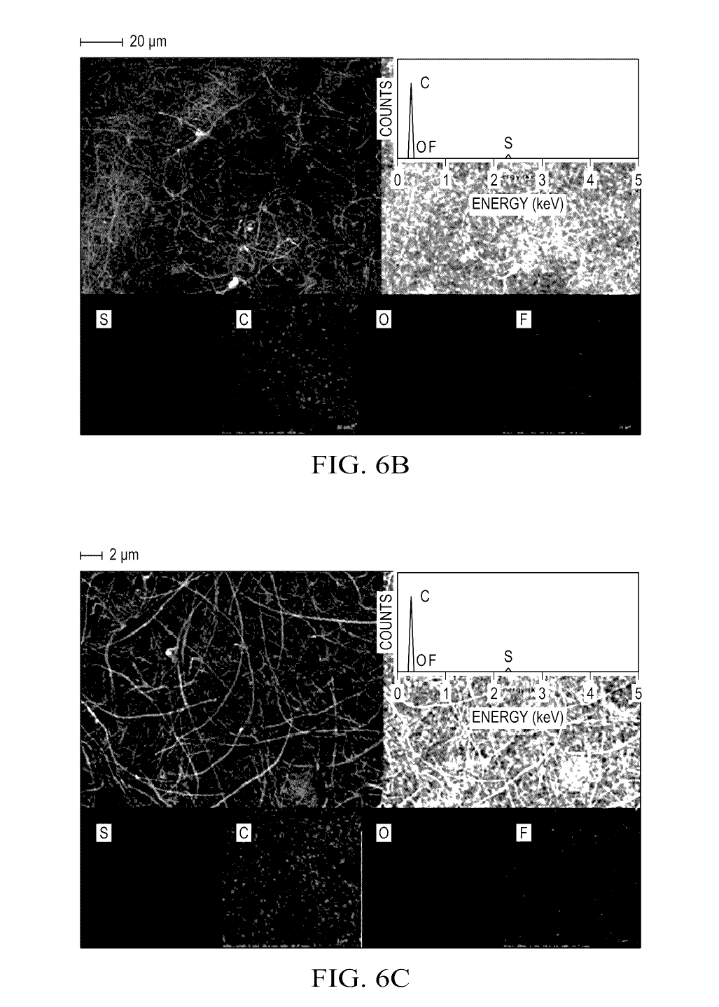

FIG. 6A provides high and low-magnification SEM images and the corresponding elemental analysis of the external surface of a buckypaper carbon layer assembled into an uncycled B/S/B-3 cathode. FIG. 6B provides another low magnification image and FIG. 6C provides another high magnification image. The retained CNT-CNF hybridized framework and strong elemental carbon signals indicate that the buckypapers are free of S before electrochemical cycling. Thus, their tortuous nanopores are available to absorb escaping polysulfides upon cycling.

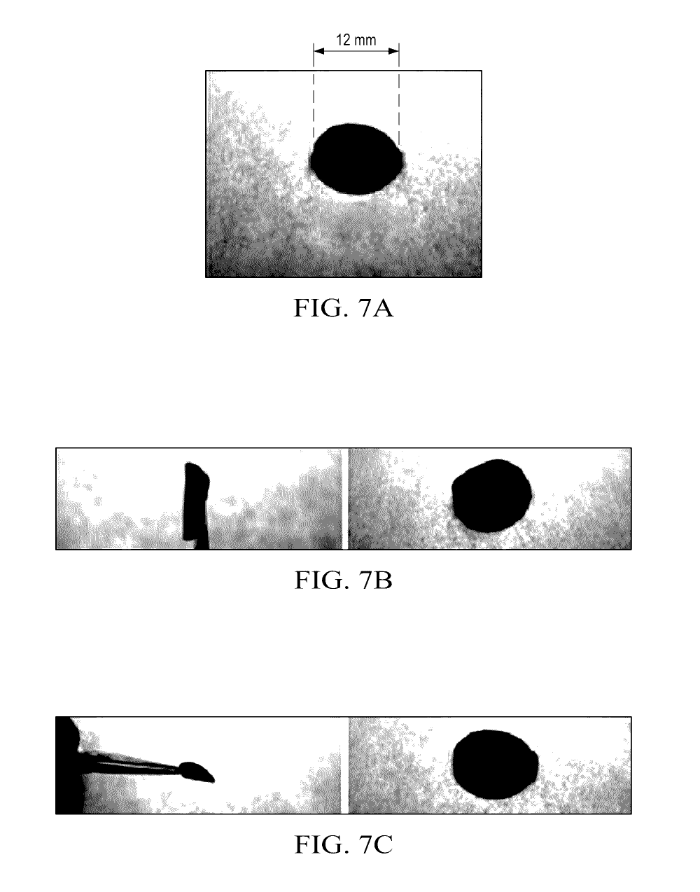

The outstanding flexibility and ductility of the free-standing B/S/B cathodes are exhibited in FIG. 7A, FIG. 7B, and FIG. 7C. The cathode material in FIG. 7A is rolled the recovered in FIG. 7B. In FIG. 7C is its multi-folded and recovered. After rolling or multi-folding, the recovered B/S/B-3 cathode displayed no delamination, demonstrating the outstanding adhesion between the S-based cathode active material composition and the conductive buckypaper carbon layers. This lack of delamination and strong adhesion allowed the B/S/B-3 cathodes to attain a low surface electrical resistivity of 1.67 Ohm/square. Furthermore, the B/S/B-3 cathode did not flake or fracture under stress.

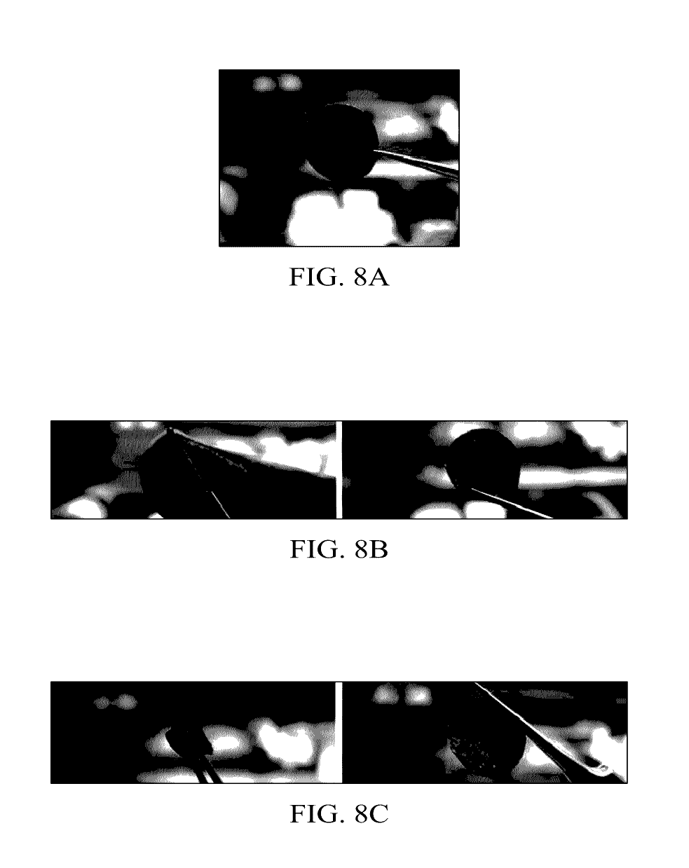

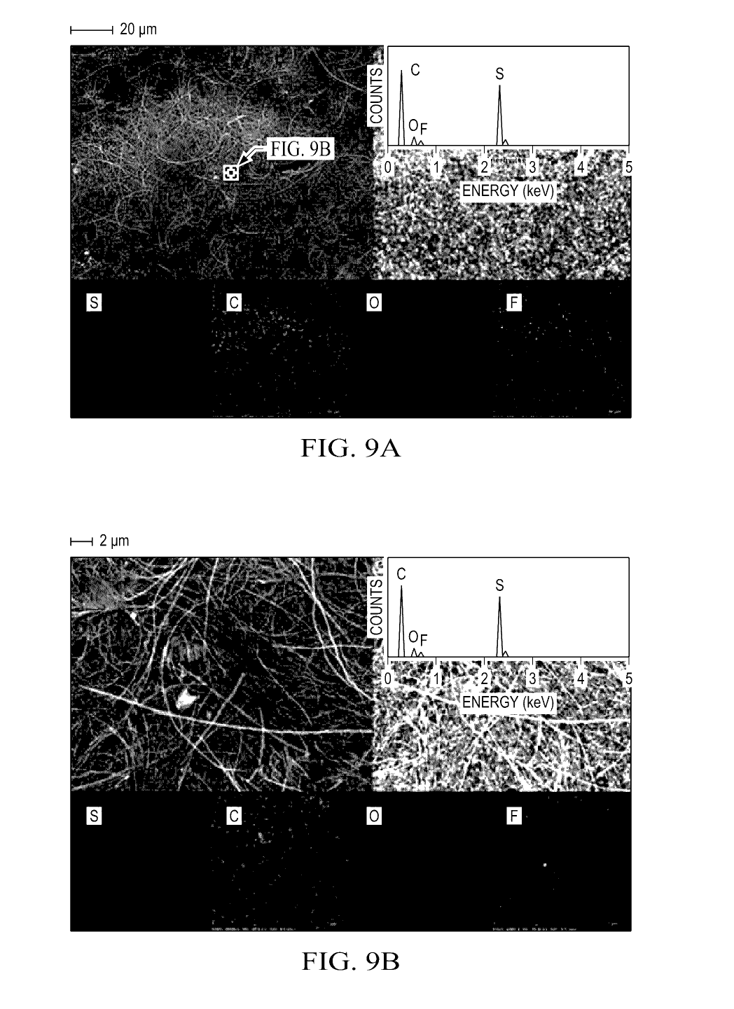

Such excellent ductility and flexibility cushion the mechanical strain from the morphological rearrangement and the huge volume change of the S-based cathode active material during cycling, which is confirmed by FIG. 8A, which shows a complete B/S/B-3 cathode after 400 cycles. The cycled B/S/B-3 cathode was also rolled and the recovered in FIG. 8B, or multi-folded and recovered in FIG. 8C to examine its remarkable mechanical strength. The recovered B/S/B-3 cathode displayed no structural distress, demonstrating that the cathode retained outstanding ductility and flexibility even after long-term electrochemical cycling.

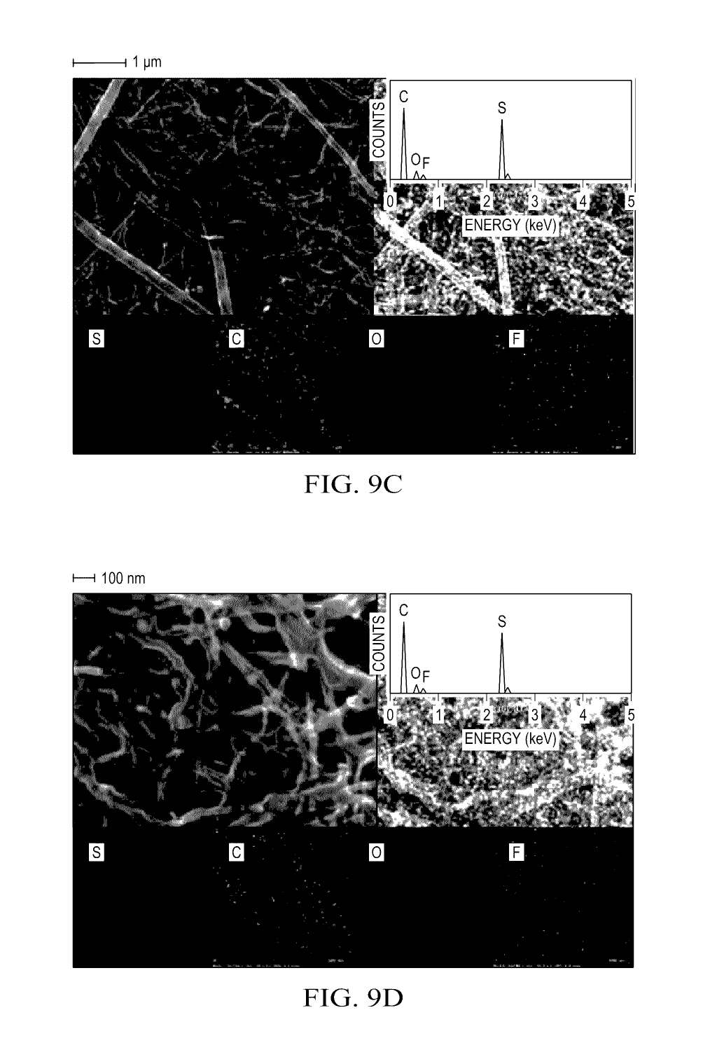

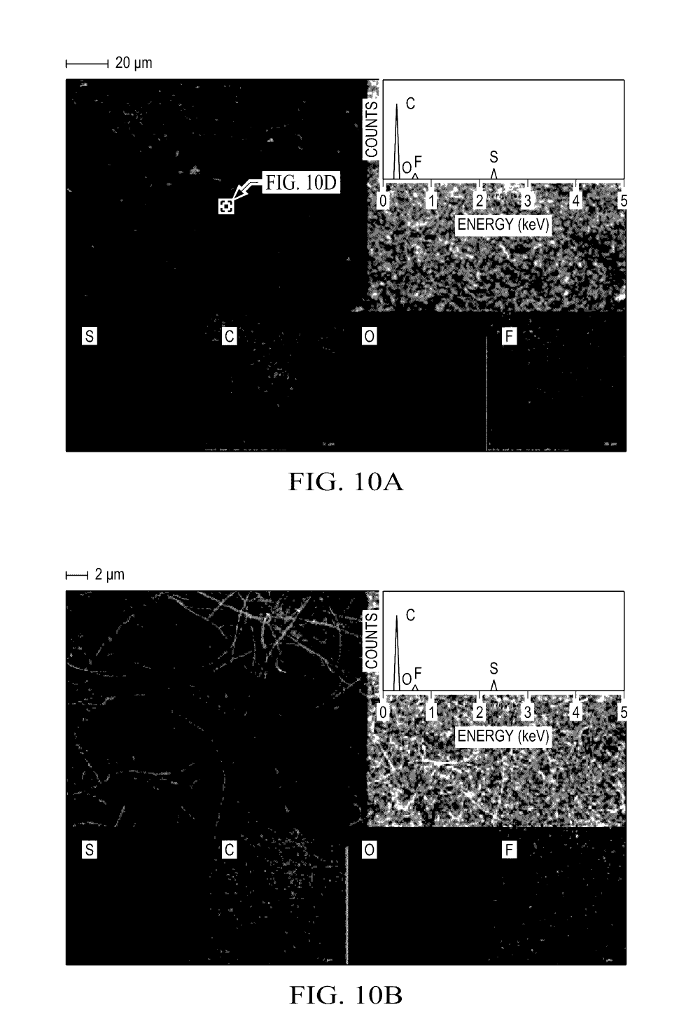

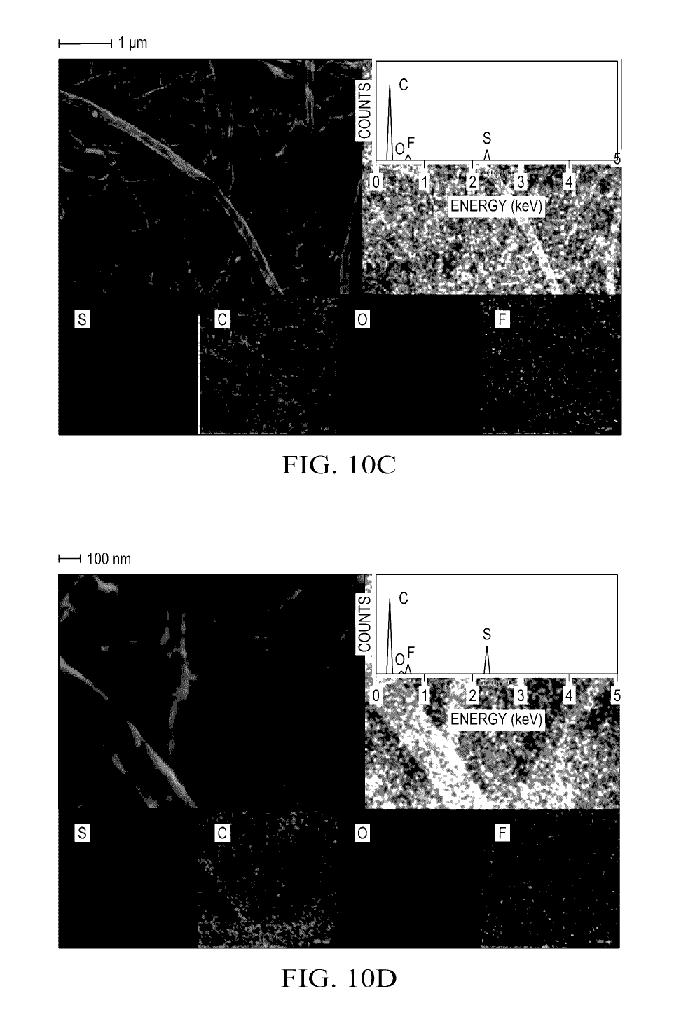

FIG. 9 and FIG. 10 present the differences in the morphological and elemental changes on the surface of a cycled buckypaper carbon layer on the anode-facing side of the cathode, where polysulfides are expected to be trapped (FIG. 10A, FIG. 10B, FIG. 10C, and FIG. 10D), and the cycled buckypaper carbon layer from the opposite side of the cathode, where a current collector is normally located (FIG. 9A, FIG. 9B, FIG. 9C, and FIG. 9D). The SEM images of the cycled buckypaper carbon layer from the current collector side of the cathode (FIG. 9) exhibited almost the same morphology as the uncycled B/S/B-3 cathode (FIG. 6) and showed no nonconductive agglomerations on the carbon layer.

Although the porous morphology is preserved during electrochemical cycling, its corresponding elemental analytical results display strong elemental S signals at both a range of magnifications (FIG. 9A, FIG. 9B, FIG. 9C, and FIG. 9D). This indicates that the polysulfides generated during cycling are absorbed by the buckypaper on the current collector side of the cathode. The absorbed cathode active material is immobilized within the carbon layer rather than freely diffusing out from the cathode, which improves its redox accessibility and electrochemical reversibility.

Although some presence of polysulfides in the carbon collector side of the cathode was expected, polysulfides diffuse from the cathode side of a cell to the anode side of the cell, such that the ability of the anode-facing carbon layer to retain polysulfides was of even greater interest. FIG. 10 demonstrates that the B/S/B cathode can retain polysulfides in the anode-facing carbon layer as well. The microstructural and elemental inspections of the cycled anode-facing buckypaper carbon layer at a range of magnifications (FIG. 10A, FIG. 10B, FIG. 10C, and FIG. 10D) revealed the unchanged morphology of the buckypaper and weak elemental S signals. The high-magnification SEM image (FIG. 10D) was taken through the interspaces of the carbon layer. This inner-layer SEM inspection detected slightly stronger S signals as compared to the general surface detection SEM. Thus, one may conclude that the dissolved polysulfides had difficulty passing through the buckypaper carbon layer.

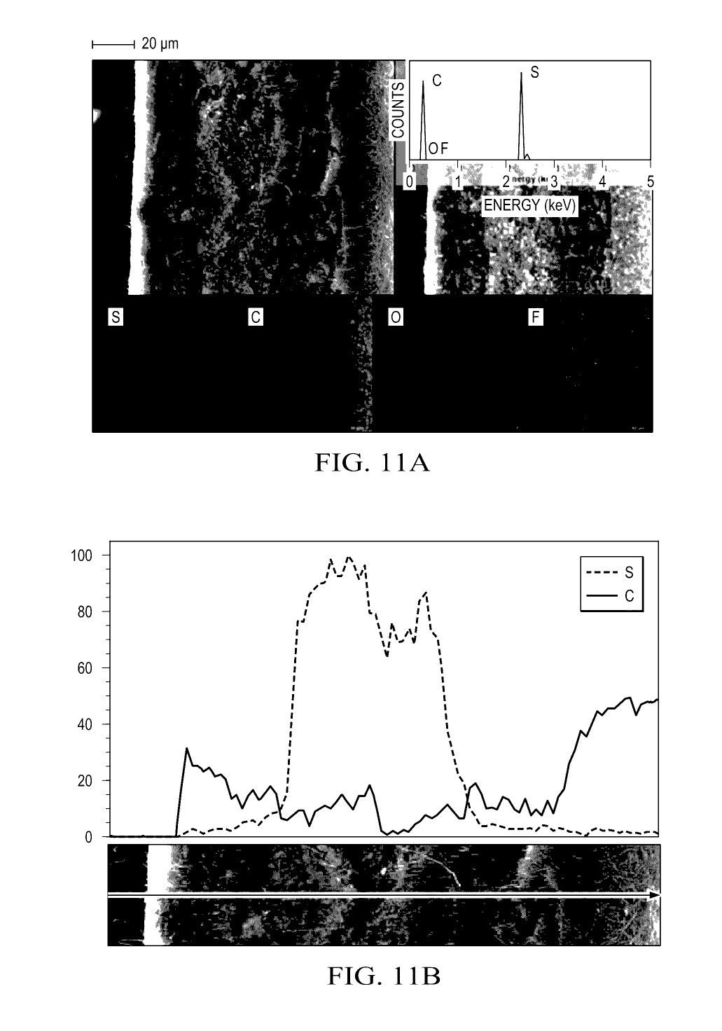

In order to observe the B/S/B cathode morphology in more detail, cross-sectional SEM inspection was performed. In FIG. 11A, a cross-sectional SEM image of the B/S/B-3 cathode and its elemental mapping before cycling illustrate strong S signals in between two layers of carbon signals. The cross-sectional sample was tilted to show the pitched cathode surface, which displays limited sulfur signals. Thus, as expected, the corresponding line-scanning result (FIG. 11B) clearly shows that the S-based cathode active material composition was stabilized within the buckypaper carbon layers.

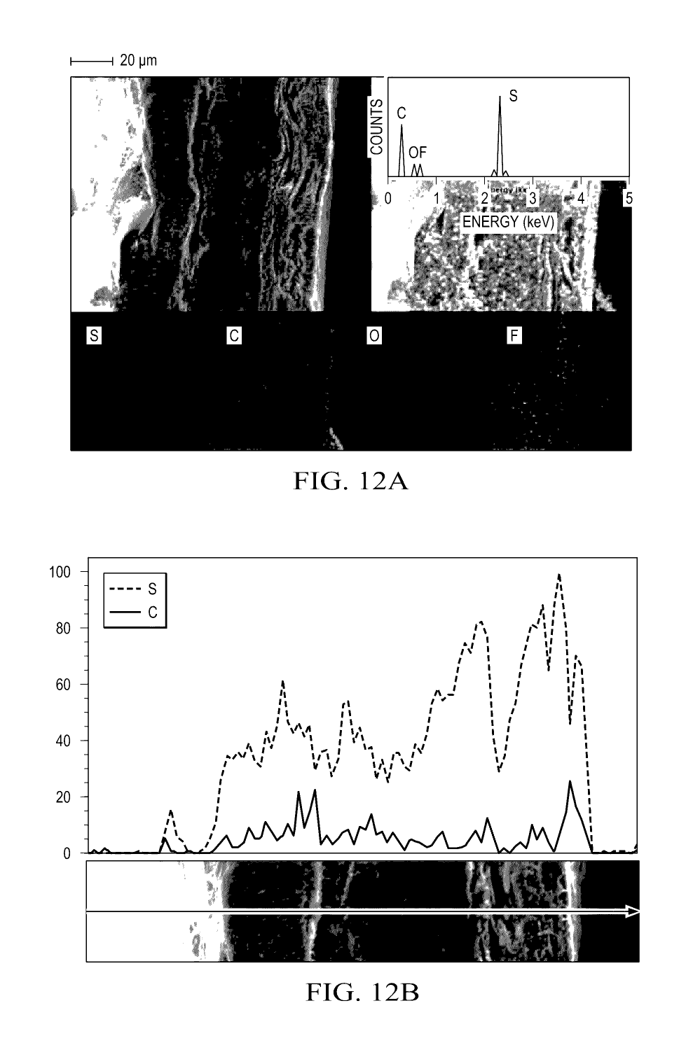

A free-standing, flexible B/S/B cathode from a Li—S cell as described in Example 2 was also analyzed. The morphological changes of the B/S/B-3 cathode after 400 cycles are revealed in the cross-sectional SEM image of FIG. 12A. In FIG. 12 A, the S-based cathode active material has entered the buckypaper carbon layers. The corresponding elemental mapping results and the line-scanning results (FIG. 12B) confirm that the cathode active material is uniformly stored in the buckypaper carbon layers. The in-situ absorption of the S-based cathode active material in the buckypaper carbon layers confines the S-based cathode active material within an intricate three-phase architecture that is made up of the S-based cathode active material, the buckypaper carbon layers, and the electrolyte. These features suppress S-based cathode active material loss and improve its electrochemical utilization and the electrochemical accessibility.

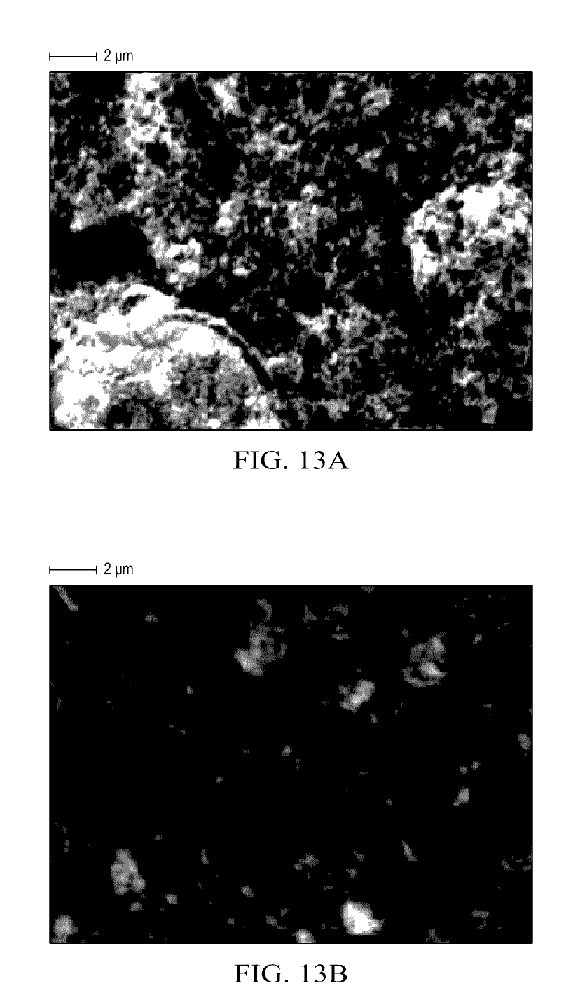

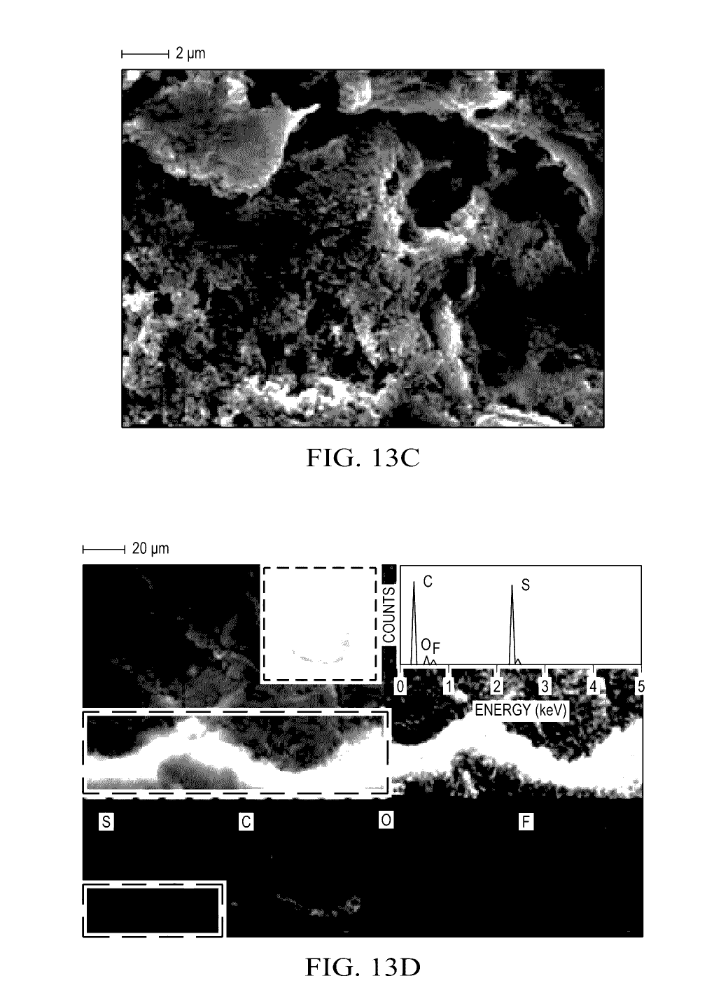

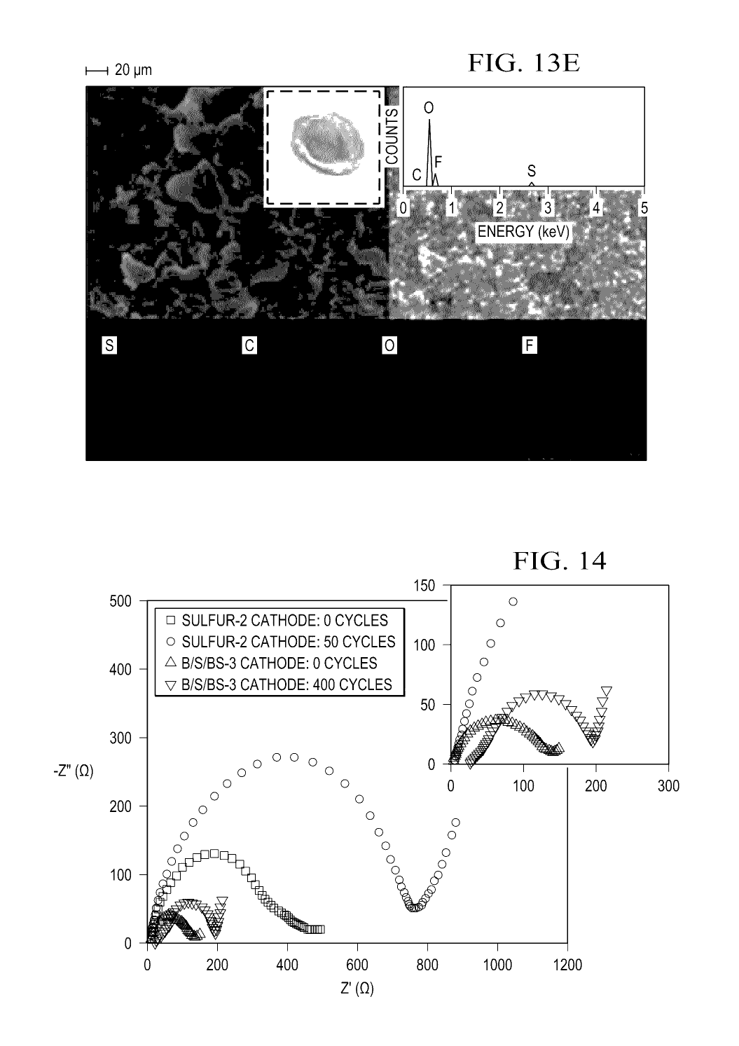

SEM was also used to examine the morphology of the S-based cathode active material composition in an uncycled B/S/B-3 cathode (FIG. 13A), a B/S/B-3 cathode after 400 cycles (FIG. 13B), and a reference S-2 cathode after 50 cycles (FIG. 13C). The unclycled cathode shows the micron-sized sulfur particles surrounded by Super P carbon black (FIG. 13A). After 400 cycles, the rearranged active material was absorbed by the carbon black matrix and the woven CNT-CNF framework (FIG. 13B). Therefore, the active-material fillings retained similar morphology during electrochemical cycling. However, the cycled conventional cathode was covered by smooth agglomerates that result from the redeposition of the diffusing polysulfides (FIG. 13C).

A B/S/B-3 cathode after 400 cycles was scraped to partially expose the S-based cathode active material composition, which was subjected to SEM analysis and elemental analysis (FIG. 13D). The exposed S-based cathode active material composition exhibited strong elemental sulfur signals as compared to that detected in the region (marked with yellow circles) still covered by the buckypaper carbon layer. This attests to the outstanding S-based cathode active material encapsulation of the cathode. Suppression of polysulfide migration was also demonstrated by the bare separator that was retrieved from the same cycled cells, which retained a white and clean surface, as shown in the inset in FIG. 13D, which displays the cathode side of the cycled Celgard separator without being rinsed by the DME/DOL solution.

The elemental analysis shows uniform elemental oxygen and fluoride signals both in the S-based cathode active material composition and exterior of the remaining carbon layer on the B/S/B-3 cathode, demonstrating proper electrolyte penetration in the interconnected pores.

On the other side, an SEM image and elemental analysis of the microstructure of the cycled Li-metal anode from the same cell is displayed in FIG. 13E. The weak elemental sulfur signals confirm that polysulfide migration was inhibited. As a result, the surface of the cycled Li anode after 400 cycles remained smooth and clean.

The electrical conductivities of the buckypaper carbon layer and the B/S/B cathodes were measured with a resistivity system (Pro4, Lucas Labs, Calif., US) equipped with a four-point-probe head (SP4, Lucas Labs) and a source meter (Model 2400 general-purpose sourcemeter, Keithley Instruments, Ohio, US). Electrochemical impedance spectroscopy (EIS) analysis was carried out with an impedance analyzer (SI 1260, Solartron, United Kingdom) equipped with the electrochemical interface (SI 1287, Solartron) in the frequency range of 10⁶ to 10⁻¹ Hz and an amplitude perturbation of 5 mV. The discharge/charge voltage profiles and cyclability data were collected with a programmable 96 channel battery cycler (Arbin Instruments, Texas, US). The cells were first discharged to 1.8 V and then charged to 2.8 V for a full cycle at 0.2 C and 0.5 C rates. The cycling rate was based on the mass and theoretical charge-storage capacity of sulfur. The capacities of the upper-discharge plateau (Q_{H}) and the lower-discharge plateau (Q_{L}) of the cells were captured from data points in the discharge curves. The theoretical values of Q_{H} and Q_{L} are, respectively, 419 and 1256 mAh/g. The Q_{L}/Q_{H} factor has a theoretical value of 2 3. The shuttle factor (SF) was calculated by the mathematical model of formula (I):

Coulombic efficiency=[2SF+In(1+SF)]/[2SF−In(1−SF)] (I)

The analyses of reference cells were stopped at 50 cycles due to the low reversible charge-storage capacity (400 mAh/g) and the severe polarization.

According to the SEM analysis of Example 3, the B/S/B cathode effects a close connection between the S-basted cathode active material and the conductive buckypaper carbon layers. How the B/SB cathodes affected the electrochemical utilization of sulfur and the subsequent conversion reactions was also examined.

EIS analyses of the B/S/B-3 cathodes before and after 400 cycles and conventional S-2 cathodes before and after 50 cycles are shown in FIG. 14. The EIS of the control cell with a conventional S-2 cathode is shown before and after 50 cycles. The B/S/B-3 cathodes display a low charge-transfer resistance (Rct=145 Ohm before cycling and 168 Ohm after cycling) and a low diffusion resistance as compared to those of the conventional S-2 cathode. This indicates that effective redox accessibility the B/S/B-3 cathodes raised the electrochemical utilization of the insulating S.

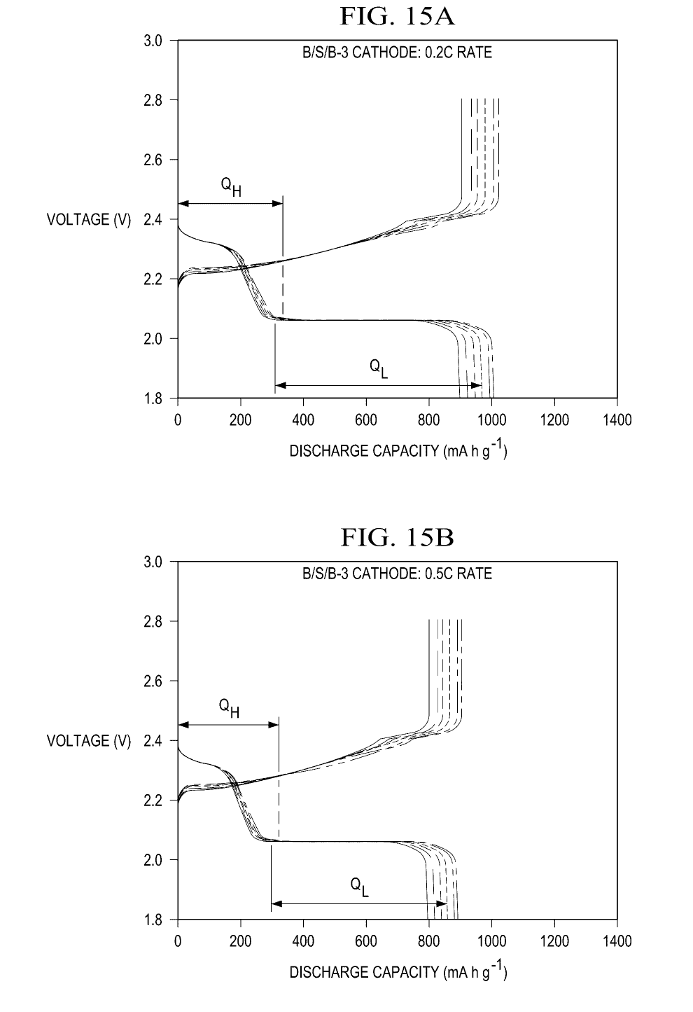

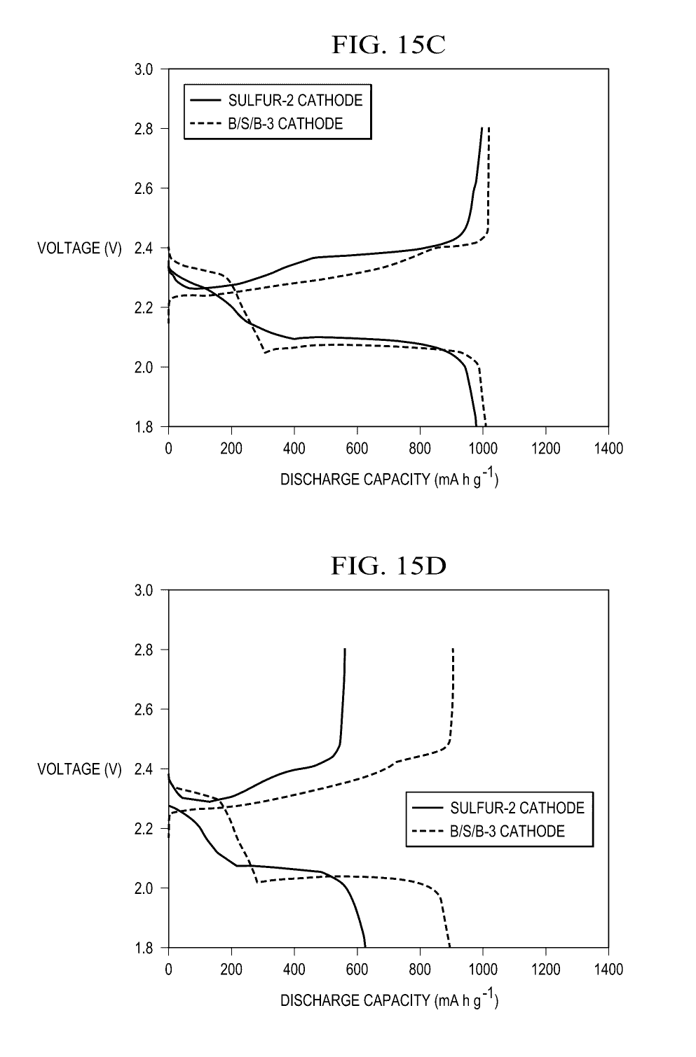

The dynamic electrochemical stability of the B/S/B cathodes is explained by the discharge/charge voltage profiles shown in FIG. 15. During cell discharge, the upper-discharge plateaus at 2.3 V involve the reduction reaction from elemental sulfur (S₈) to high-order lithium polysulfides. The lower discharge plateaus at 2.1 V correspond to the reduction reaction of soluble high-order lithium polysulfides to insoluble Li₂S₂/Li₂S. The discharge capacities of the B/S/B-3 cathodes approach 1010 and 891 mAh/g at, respectively, 0.2 C (FIG. 15A) and 0.5 C rates (FIG. 15B). The B/S/B-3 cathodes improve the initial charge-storage capacity by 3% at 0.2 C rate (FIG. 15C) and up to 44% at 0.5 C rate (FIG. 15D) as compared to the conventional S-2 cathodes.

During cell charge, the two continuous charge plateaus at 2.3 and 2.4 V indicate the reversible oxidation reactions from a Li₂S₂/Li₂S mixture to high-order lithium polysulfides. In different cycles, the overlapping discharge and charge plateaus display no obvious capacity fade or voltage changes, illustrating superior electrochemical reversibility at various cycling rates (FIG. 15A and FIG. 15B). Furthermore, the B/S/B-3 cathodes display lower polarization than the conventional S-2 cathodes (FIG. 15C and FIG. 15D). These two characteristics demonstrate the limited loss of active material and the lack of nonconductive Li₂S₂/Li₂S agglomerations on the electrode surface.

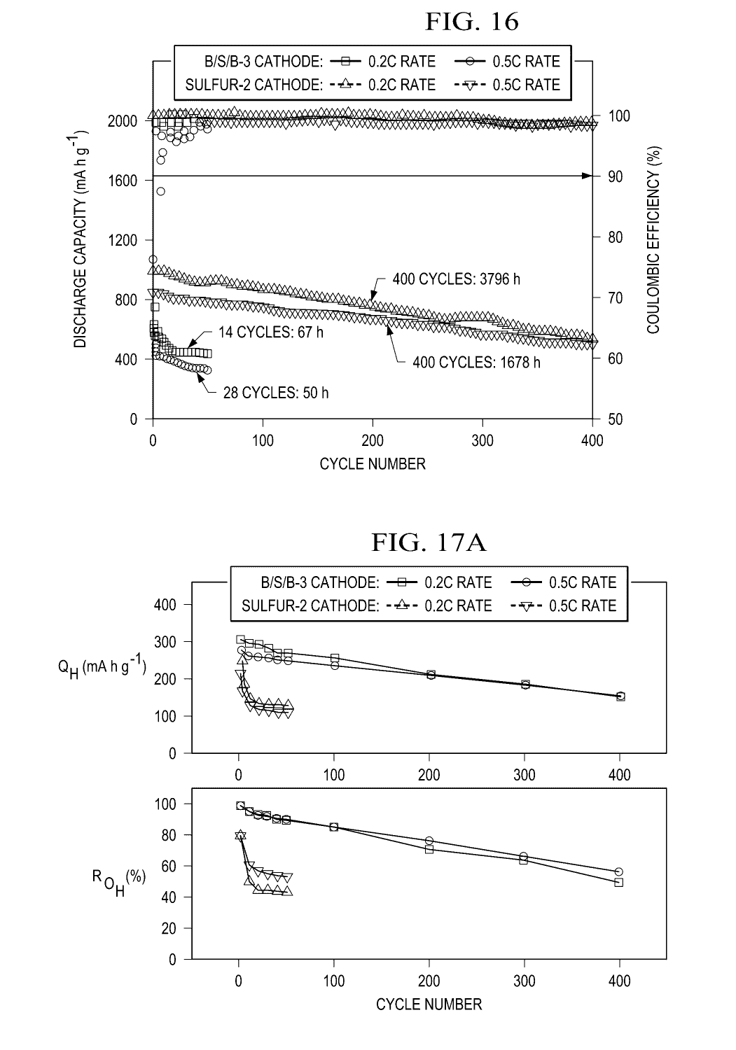

In FIG. 16, the cycling profiles of the cells employing B/S/B-3 cathodes show superior cycling stability with reversible discharge capacities of 516 mAh/g (0.2 C rate) and 504 mAh/g (0.5 C rate) after 400 cycles. The corresponding capacity fade rates (with the capacity retention rates in parentheses) are 0.07% per cycle (51% at 0.2 C rate) and 0.06% per cycle (57% at 0.5 C rate). This performance is better than that of a S-2 cathode with a conventional cathode configuration, which showed a fast capacity fade of 0.65% and 0.36% per cycle in 50 cycles at, respectively 0.2 C and 0.5 C rates.

The superior cycle stability of the B/S/B-3 cathodes is further explained by considering the reversible capacity and the cell operation time. B/S/B-3 cathodes performed suitably over 3700 h at 0.2 C rate and 1600 h at 0.5 C rate. As a reference, the S-2 cathodes with the same capacity retention level only suitably cycled for 67 h (capacity retention rate=51% at the 14th cycle) and 50 h (capacity retention rate=57% at the 28th cycle) at, respectively, 0.2 C and 0.5 C rates. This demonstrates a 50-fold enhancement on the cell operation time for a cell employing the B/S/B-3 cathode.

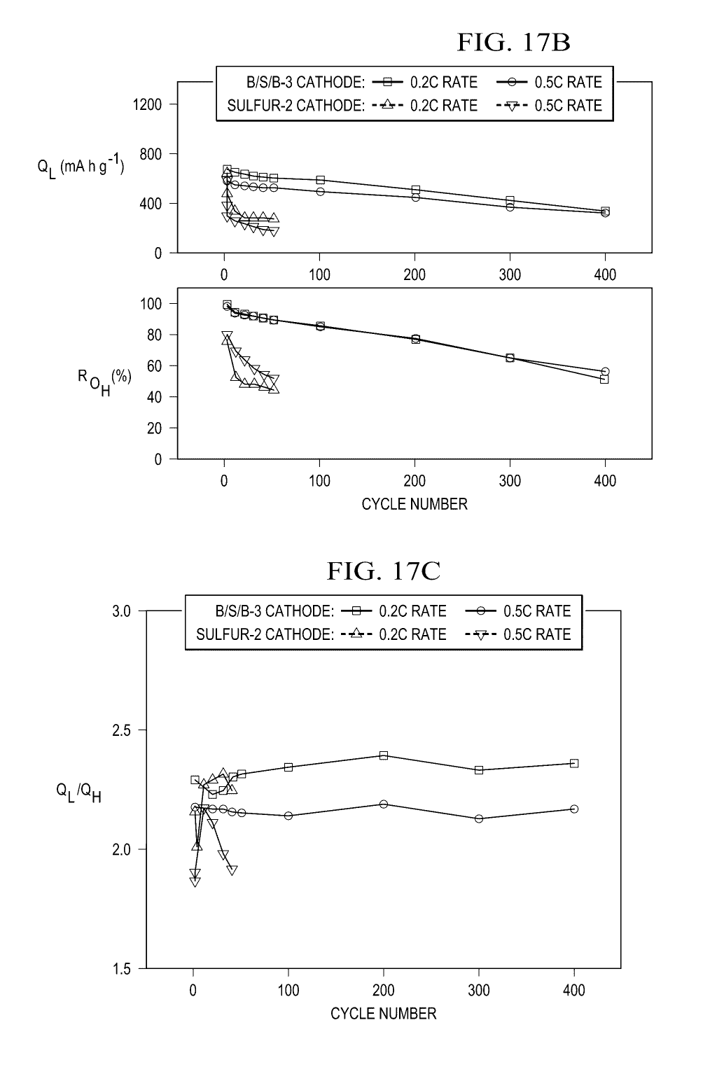

The enhanced cell performance could be explained in detail by the Q_{H}/ Q_{L}analysis. Q_{H} and the retention reflect the polysulfide retention level of the B/S/B cathode. The upper-discharge plateau involves the solid_{(sulfur)}-to-liquid_{(polysulfides)} phase transition that relates to the production and diffusion of polysulfides. FIG. 17A shows the Q_{H} (upper part) and its retention rate (R_{QH}: lower part) for a B/S/B-3 cathode. The B/S/B-3 cathodes attain high Q_{H} utilization rate of 73% and 67% at, respectively, 0.2 C and 0.5 C rates. The R_{QH} at various cycling rates approaches 60% after 400 cycles. The high Q_{H} reversibility demonstrates the excellent polysulfide retention in the cathode.

The porous carbon layers in the B/S/B cathodes hold and absorb the rearranged S-based cathode active material during cell cycling, which prevents severe polysulfide diffusion. The rearranged S-based cathode active material also uniformly remains at stable absorption positions that are closely connected with the electrically conductive skeleton of the buckypapers, which allows the cathode active material to reach the most electrochemically stable position in the B/S/B cathode.

The enhanced reaction capability of B/S/B cathodes was demonstrated using Q_{L} because the lower-discharge plateau involves slow electrochemical reactions with low reaction kinetics. The capability to efficiently discharge a high storage-Q_{L} reflects the high redox accessibility of the B/S/B cathode for converting the trapped polysulfides into the end-discharge products. In FIG. 17B, the B/S/B-3 cathodes show high initial Q_{L} utilizations of 56% at 0.2C rate and 49% at 0.5 C rate, illustrating a more thorough reduction of the trapped polysulfides as compared to that of the conventional S-2 cathodes. After 400 cycles, as expected, the B/S/B cathodes retained a high Q_{L} retention rate approaching 60%. This reflects the better redox accessibility than the S-2 cathode, which loses more than half of its initial Q_{L} in 50 cycles.

The Q_{L}/Q_{H} factors for the B/S/B cathode and a conventional S-2 cathode are illustrated in FIG. 17C. Theoretically, the Q_{L}/Q_{H} value should be between 2 and 3. Deviation from this theoretical value may be used to assess the irreversible capacity loss resulting from the severe polysulfide diffusion and the inefficient conversion processes. As a result, the high Q_{L}/Q_{H} ratios of B/S/B-3 cathodes for 400 cycles (2.2-2.4) confirm their effective polysulfide retention and conversion capability. As a reference, the S-2 cathode has a low and unstable Q_{L}/Q_{H} ratio (1.8-2.3).

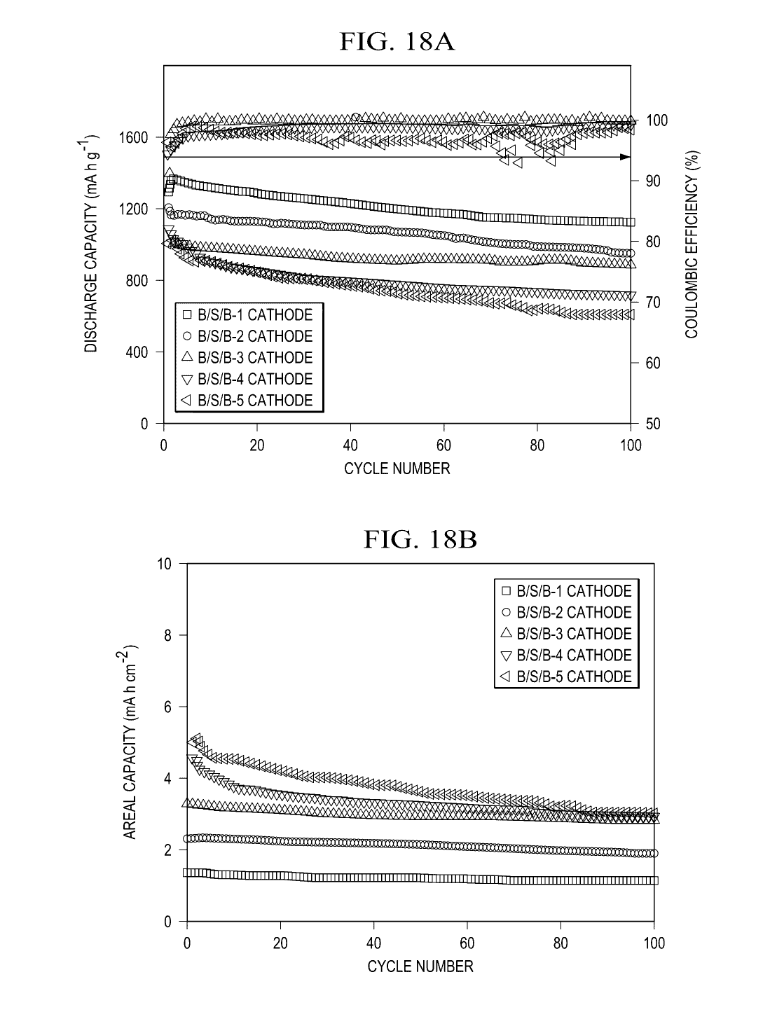

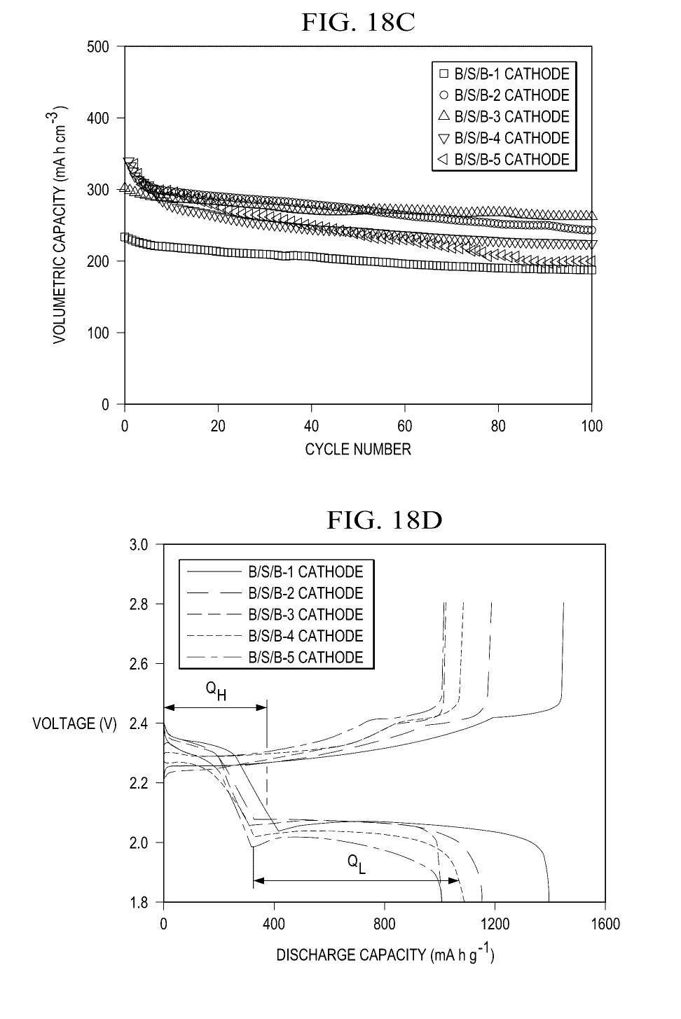

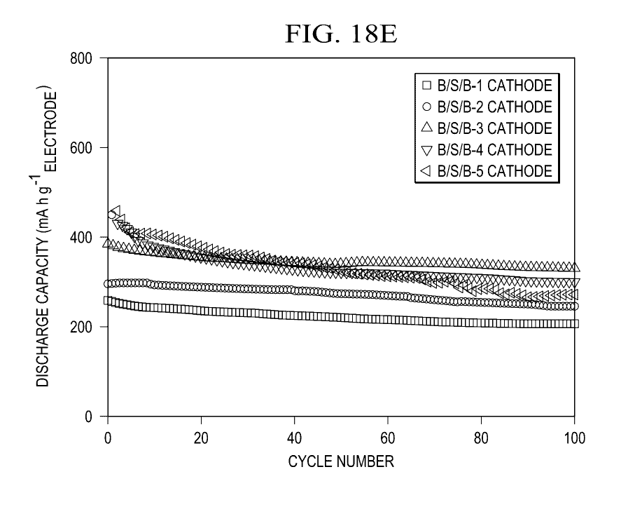

Cells employing B/S/B cathodes with various sulfur loadings, B/S/B-1 to B/S/B-5 were also tested at a 0.2 C rate to determine the effects of sulfur loading on discharge capacity (FIG. 18A), areal capacity (FIG. 18B), volumetric capacity (FIG. 18C), and discharge profile (FIG. 18D). The B/S/B-1 cathode showed outstanding cycle stability with a high sulfur utilization of 83% and a high capacity retention rate up to 81% after 100 cycles (FIG. 18E). The improved cycle stability was found even after increasing the sulfur loading by almost six times due to the unique electrode structure that stabilizes the S-based cathode active material composition within the buckypaper carbon layers. The charge/discharge voltage profiles remained similar.

The Li—S coin cell performance was further enhanced by including MPC/PEG-coated separator. The porous and conductive MPC/PEG coating on the separator was arranged adjacent to the B/S/B cathode to facilitate cooperation with the adjacent buckypaper in trapping polysulfides. In addition, this conductive coating layer functions as an upper current collector coupled with the conductive CNT-CNF framework of the buckypaper electrodes and so greatly enhanced the overall cell performance.

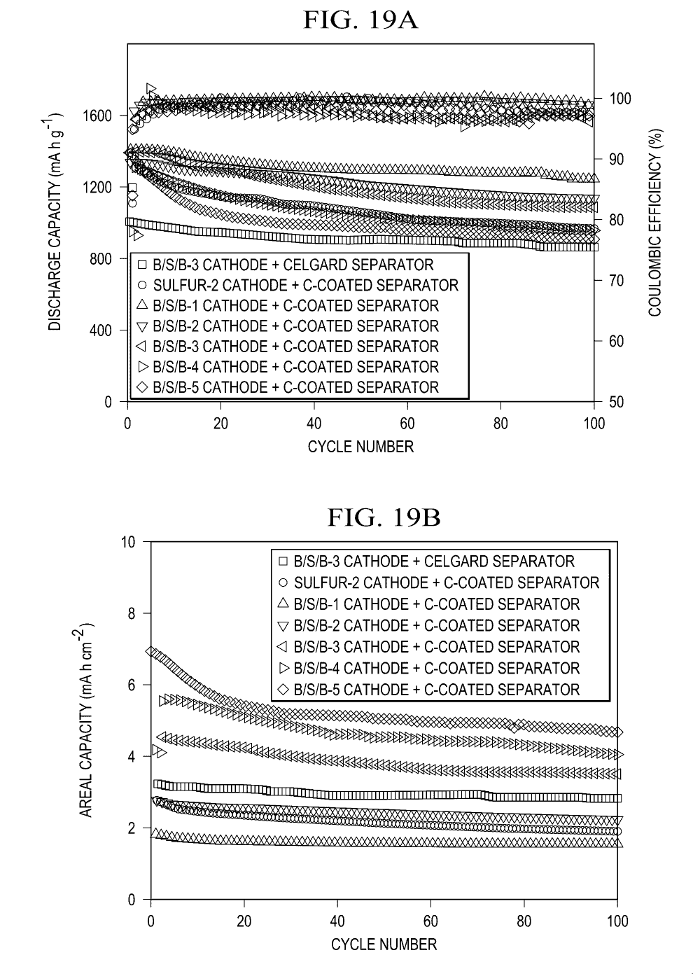

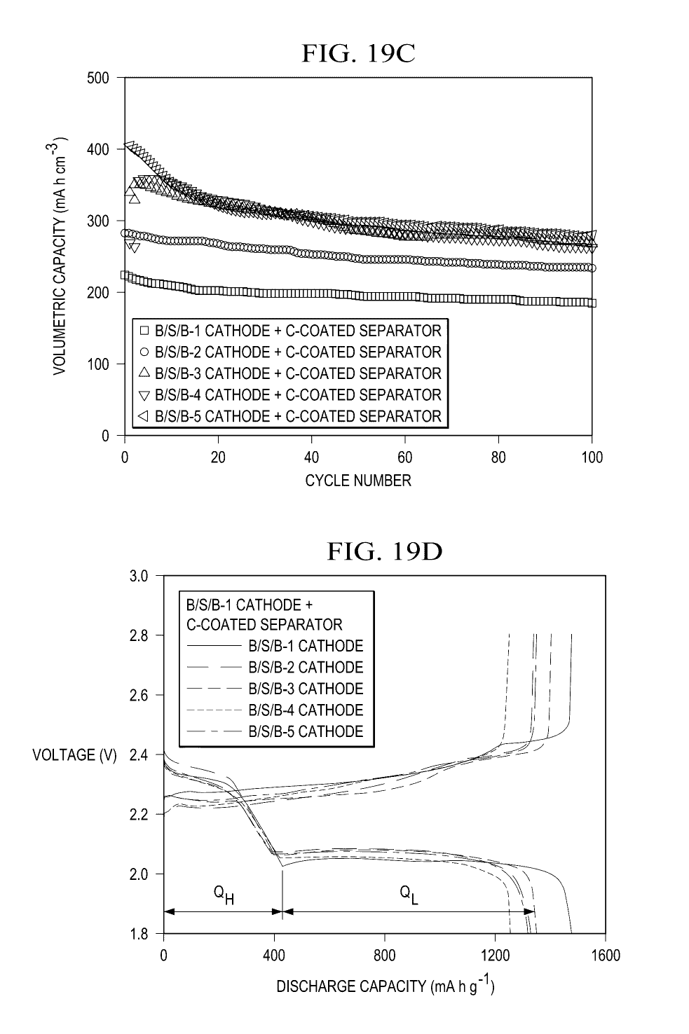

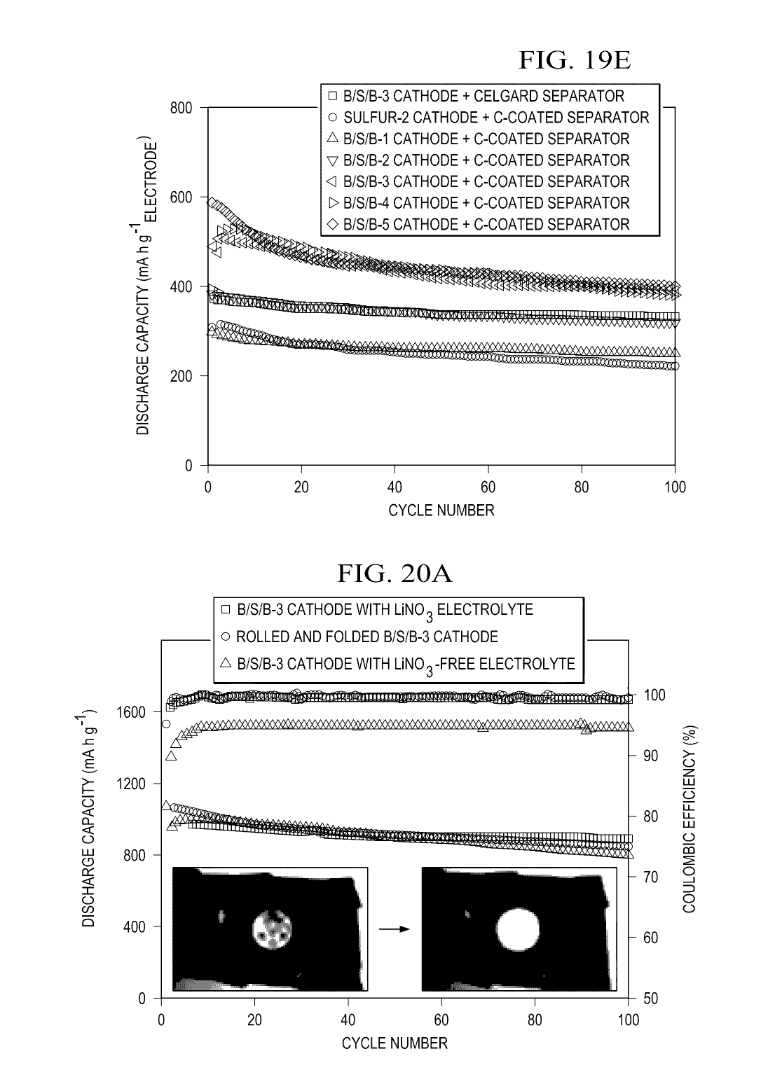

With the MPC/PEG-coated separator, the initial discharge capacity of the B/S/B-3 cathodes was from 1010 mAh/g to 1400 mAh/g (FIG. 19A), corresponding to over a 39% improvement over the electrochemical utilization of conventional S-based cathodes. Areal capacity (FIG. 19B) and volumetric capacity (FIG. 19C) was also significantly improved by the inclusion of the MPC/PEG-coated separator, while the charge/discharge voltage profile remained unaffected (FIG. 19D) and cyclability remained high (FIG. 19E). Therefore, the synergistic effect from these two coin cell components formed high-performance Li—S cells that employed high-S-based cathode active material-loading cathodes.

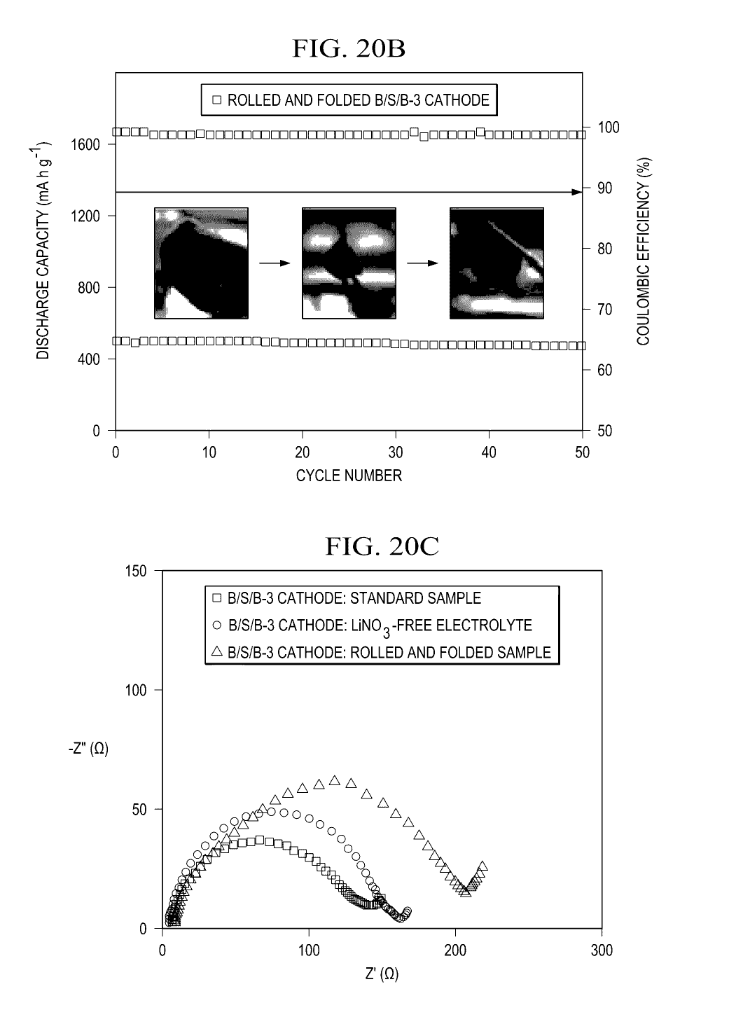

FIG. 20A demonstrates that a B/S/B-3 structural cathode that was rolled and subsequently folded was able to power a white red light-emitting diode (LED) and exhibited almost the same cycle stability as compared to an unrolled/folded B/S/B-3 cathode for 100 cycles. FIG. 20B further displays the stable cycling performance of a cell employing the cycled B/S/B-3 cathode that was also rolled and folded in FIG. 8. The cycled B/S/B-3 cathode was reassembled into a coin cell and the cell performance was evaluated in the subsequent 50 cycles (from 401st-450th cycles). The cell exhibited similar cyclability with outstanding cycle stability. The corresponding capacity fade rate and the capacity retention rate are, respectively, 0.05% per cycle and 92%. Such stable electrochemical performance of the cells employing the rolled and folded B/S/B-3 structural cathodes, even when rolled or folded after some cycling, demonstrated the B/S/B cathode as a robust, ultra-tough, flexible structural electrode.

Furthermore, FIG. 20C as compared to FIG. 15 indicates that the B/S/B cathode retained a similar cathode impedance after being rolled and crumpled, attesting to its high flexibility and mechanical stability.

### Example 4—Electrolyte Effects

LiNO₃ salts are included in electrolytes of Li—S batteries to directly stabilize the Li anode by forming a passivating NOₓ film. Cells of the present disclosure, due to low amounts or no polysulfide reaching the anode, may not benefit from these salts. FIG. 20A shows that cells without LiNO₃ salts have a discharge capacity similar to that of cells with these salts in the electrolyte for 100 cycles. FIG. 20C demonstrates that EIS data is also similar for cells with or without LiNO₃ salts, so long as a cathode of the present disclosure is used.

Thus, LiNO₃ salts may be omitted from batteries using cathodes of the present disclosure. Furthermore, the results in FIG. 20A and FIG. 20C confirm that the B/S/B cathodes tested were substantially able to retail polysulfides.

Although only exemplary embodiments of the disclosure are specifically described above, it will be appreciated that modifications and variations of these examples are possible without departing from the spirit and intended scope of the disclosure. For instance, numeric values expressed herein will be understood to include minor variations and thus embodiments “about” or “approximately” the expressed numeric value unless context, such as reporting as experimental data, makes clear that the number is intended to be a precise amount.

1. A cathode comprising:
a first carbon layer;
a second carbon layer; and
a sulfur(S)-based cathode active material composition between the first and second carbon layers, wherein at least one of the first and second carbon layers allows passage of lithium ions, while substantially preventing passage of polysulfides.

2. The cathode of claim 1, wherein both the first and second carbon layers allow passage of lithium ions while substantially preventing passage of polysulfides.

3. The cathode of claim 1, further comprising at least one additional carbon layer.

4. The cathode of claim 1, wherein both carbon layers are formed from the same material.

5. The cathode of claim 1, wherein the carbon layer that allows passage of lithium ions, while substantially preventing passage of polysulfides comprises a nanocarbon paper.

6. The cathode of claim 5, wherein the nanocarbon paper comprises curved carbon nanotubes attached to a carbon nanofiber skeleton to form a binder-free SP²-hydridized carbon framework.

7. A lithium-sulfur (Li—S) battery comprising:
an anode;
an electrolyte; and
a cathode comprising:
a first carbon layer;
a second carbon layer; and
a sulfur(S)-based cathode active material composition between the first and second carbon layers,
wherein at least one of the first and second carbon layers allows passage of lithium ions, while substantially preventing passage of polysulfides.

8. The battery of claim 7, wherein both the first and second carbon layers allow passage of lithium ions while substantially preventing passage of polysulfides.

9. The battery of claim 7, further comprising at least one additional carbon layer.

10. The battery of claim 7, wherein both carbon layers are formed from the same material.

11. The battery of claim 7, wherein the carbon layer that allows passage of lithium ions, while substantially preventing passage of polysulfides comprises a nanocarbon paper.

12. The battery of claim 11, wherein the nanocarbon paper comprises curved carbon nanotubes attached to a carbon nanofiber skeleton to form a binder-free SP²-hydridized carbon framework.

13. The battery of claim 7, wherein the battery has a capacity fade of no more than 1% per cycle for at least 400 cycles.

14. The battery of claim 7, wherein the cathode has an areal capacity of at least 5 mAh/cm², as measured per surface area of one carbon layer.

15. The battery of claim 7, wherein the cathode has a sulfur (S) loading of at least 3 mg/cm² as measured per surface area of one carbon layer.

16. The battery of claim 7, wherein the cathode has a volumetric capacity of at least 250 mAh/cm³.

17. The battery of claim 7, wherein the cathode has a weight capacity of at least 450 mAh/g.

18. The battery of claim 7, wherein battery has initial discharge capacity of at least 750 mAh/g.

19. The battery of claim 7, wherein the cathode does not delaminate when rolled or folded.

20. The battery of claim 7, wherein the cathode does not disintegrate due to volume changes in a cathode active material between charge and discharge of the battery.

21. The battery of claim 7, wherein the cathode does not experience loss of electrical conductivity loss due to volume changes in a cathode active material between charge and discharge of the battery.
